(19) United States
(12) Patent Application Publication
(10) Pub. No.: US 2026/0316792 A1
(43) Pub. Date: Oct. 15, 2026

(54) TARGET OBJECT AND FEATURE MINING

(71) Applicant: NVIDIA Corporation, Santa Clara, CA (US)

(72) Inventors: Tao FU, Shanghai (CN); Sakib Ar RAHMAN, Houston, TX (US); Shanshan XU, Palo Alto, CA (US); Weiwei KANG, San Jose, CA (US); Yifang XU, Saratoga, CA (US)

(21) Appl. No.: 19/255,606

(22) Filed: Jun. 30, 2025

(30) Foreign Application Priority Data
Apr. 10, 2025 (CN) 202510449440.3

(51) Int. Cl. B60W 60/00

(52) U.S. Cl. CPC B60W 60/0027; B60W 2520/125

(57) ABSTRACT

Autonomous and/or semi-autonomous machine performance benefits from learning many different scenarios that a machine (ego machine) may encounter, particularly those relating to other machines (agent machines) encountered in the environment. By tracking the agent machines, varying parameters of relative movement between an ego machine and the agent machines, and varying parameters of surface and weather conditions, and traffic conditions, it is possible to create many more sophisticated scenarios than has been possible with prior approaches, and thus improve the training of one or more machine learning systems on the ego machine. According to different aspects, it is possible to provide traffic scenarios involving occlusions which prevent an ego machine from identifying and being able to react to conditions in the ego machine's path. The conditions may involve pedestrians, bicycles, or one or more agent machines.

### CROSS REFERENCE TO RELATED APPLICATIONS

This application claims the priority of co-pending Chinese patent application titled, TARGET OBJECT AND FEATURE MINING, filed on Apr. 10, 2025, and having Serial No. 202510449440.3. The subject matter of this related application is hereby incorporated herein by reference.

### BACKGROUND

Autonomous and semi-autonomous vehicle, robot, and/or other machine performance benefits from training one or more machine learning systems on the machines on many different (e.g., traffic, warehouse, etc.) scenarios, particularly those relating to objects encountered during navigation or use. Devising sufficient scenarios for a database, and having queries to the database more readily available, would be desirable.

As such, a need exists for more efficient and expressive scenario mining framework for effective techniques to train vehicles, robots, and/or other machines in order to improve planning, control, navigation and/or other tasks performed by machines.

### BRIEF DESCRIPTION OF THE DRAWINGS

The present systems and methods for target object and feature mining are described in detail below with reference to the attached drawing figures, wherein:

FIG. 1 illustrates a computing device configured to implement one or more aspects of various embodiments;

FIG. 2 illustrates a scenario development system that includes the data-generation pipeline, training engine, and execution engine of FIG. 1, according to various embodiments;

FIGS. 3A-3P depict different scenarios according to various embodiments;

FIG. 4A illustrates an example input object and output object associated with a set of filtering functions, according to various embodiments;

FIG. 4B illustrates aspects of the disclosed system, according to various embodiments;

FIG. 4C illustrates an example mining scenario, according to various embodiments;

FIG. 5 illustrates a flow diagram of a method for mining of scenarios to train one or more machine learning models to define additional scenarios, according to various embodiments;

FIG. 6 is a more detailed illustration of the data-generation pipeline of FIG. 2, according to various embodiments;

FIG. 7 illustrates an example set of a scenario defined by the data-generation pipeline of FIG. 2, according to various embodiments;

FIG. 8 illustrates a flow diagram of a method for generating scenarios associated with a vehicle in an environment, according to various embodiments;

FIG. 9A is an example of sensor locations having corresponding fields of view or sensory fields for example autonomous or semi-autonomous machines, in accordance with at least some embodiments of the present disclosure;

FIG. 9B is an illustration of an example of component and sensor locations on an autonomous or semi-autonomous vehicle, in accordance with at least some embodiments of the present disclosure;

FIG. 9C is a block diagram of an example system architecture for an autonomous or semi-autonomous vehicle, robot, and/or other machine type, in accordance with at least some embodiments of the present disclosure;

FIG. 9D is a block diagram of an example architecture of a computing system such as a system-on-a-chip (SoC)—in accordance with at least some embodiments of the present disclosure;

FIG. 9E is a system diagram for communication between cloud-based server(s) and an example autonomous or semi-autonomous vehicle, robot, and/or other machine type, in accordance with at least some embodiments of the present disclosure;

FIG. 10 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 11 is a block diagram of an example computing system for generative artificial intelligence (AI), in accordance with at least some embodiments of the present disclosure; and

FIG. 12 is a block diagram of an example computing device, in accordance with at least some embodiments of the present disclosure.

### DETAILED DESCRIPTION

The disclosed systems and methods related to object tracking help to create many more sophisticated scenarios than has been possible with prior approaches. According to different aspects, it is possible to provide traffic scenarios involving multiple agents (which may be referred to herein as agent machines, agent robots, target vehicles, target robots, actors, objects, features, or obstacles), as well as occlusions which prevent an ego machine (with a plurality of sensors) from identifying and being able to react to conditions in and around the ego machine. Where there are multiple agents involved, the disclosed technique enables tracing and tracking of all such agents.

There are visual language model (VLM) based image retrieval systems which are good at catching open vocabulary semantics, compositional relations among multiple agents, and environmental signals. In the autonomous driving domain, knowledge of vehicle dynamics, including dynamic interactions among multiple agents, are necessary to enable safe, successful autonomous driving. The systems and methods described herein facilitate capturing of vehicle dynamics, trajectories of dynamic objects, and dynamic interactions among multiple agents. In this fashion, the described systems and methods bridge a gap between VLMs and autonomous driving scenarios.

As an example, VLM based image retrieval systems may capture a pedestrian crossing a street while walking a dog on a rainy day. The described systems and methods add information about an ego machine's direction, speed, acceleration, and/or distance from the crossing where the pedestrian is walking. As another example, VLM based image retrieval systems may capture a pedestrian walking on a sidewalk at night as an ego machine is backing down a driveway onto a street. Here again, the described systems and methods add information about an ego machine's direction, speed, acceleration, and/or distance from the pedestrian. The described systems and methods enable VLM based image retrieval systems to capture rare, complex, or unexpected driving scenarios that basic driving scenarios may not represent as well. Capturing these driving scenarios facilitates training of the one or more machine learning models which will provide instruction to the ego machine.

Systems and methods are disclosed related to target object and feature mining to develop a large number of scenarios-examples of which are provided herein-to train one or more machine learning systems in autonomous and/or semi-autonomous vehicles, robots, and/or other machine types. Aspects of the disclosed systems and methods enable creation of many different scenarios from basic scenarios. For example, by describing scenario aspects such as types and numbers of objects; relative distance, speed, and acceleration between an ego machine and an agent machine and/or an object; information about occlusions; and/or temporal spatial relationships between an ego machine and an object, it is possible to vary parameters of each of these scenario aspects and produce a large number of scenarios.

In some aspects, scenarios may involve not only agent machines or robots as objects, but also occlusions which can be constituted by one or more agent machines or robots hidden by one or more other agent machines or robots, or by one or more pedestrians who may be hidden by one or more agent machines, robots, or other objects,

In other aspects, the disclosed systems and methods provide a unified data interface to enable the mining of data from different sources. These sources may include an offline perception and tracking system; online object detection and tracking; and a human 4DGT (ground truth) labeling system. The unified data interface may query a database to download data such as agent trajectories and properties, and segment labels which mark specific data with one or more specific properties, relating for example to road and weather conditions, among other things. Once a query result is created, it may be cached for faster retrieval than repeated querying of the database itself.

The disclosed systems and methods close a gap between foundation vision language models and the self-driving vehicle or robotics domain, and enable wider usage of a vision language models in a self-driving or robotics domain. Target object and feature mining can specify, for example, ego speed, distance between ego and target agent, etc. These parameters are usually inaccurate from the large vision language model's direct output.

As described herein, a scenario may be considered to be a collection of object spans, which are the start and end time of a given object. For example, in a scenario involving multiple objects, such as trucks, parked back to back, the scenario may include an object span to represent each of the trucks. The scenario also may include video from cameras on board the ego machine.

In some embodiments, focusing on a segment of an object instead of the entire object may be more efficient because, for a given scenario, only some portion of an object's trajectory may be of interest. In addition, in a given category of scenarios, a single object could appear multiple times, making it desirable to create multiple scenarios for the object.

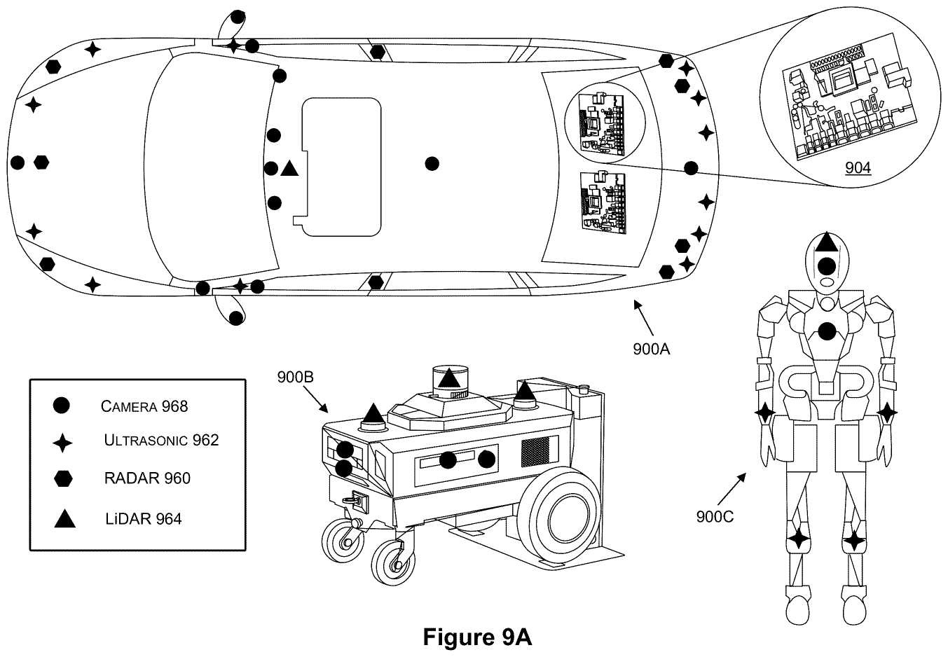

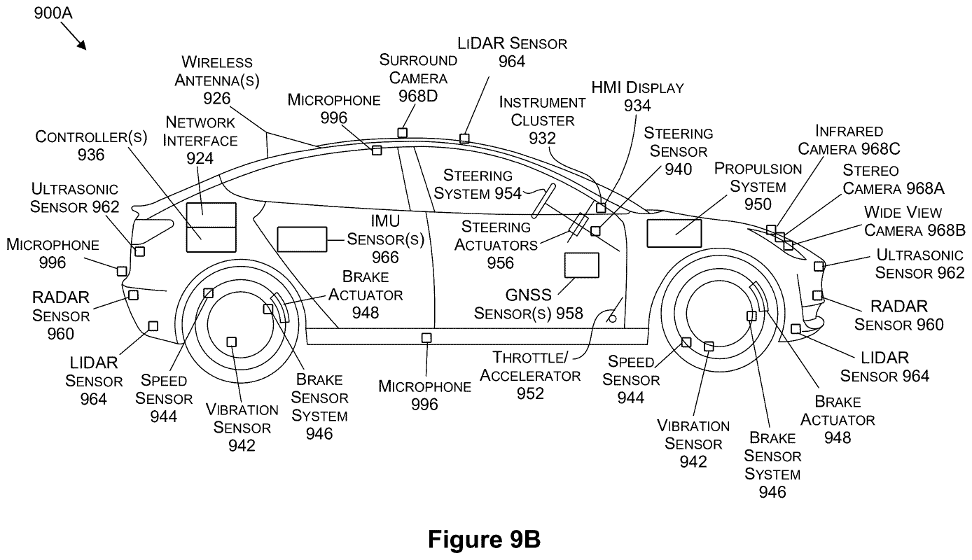

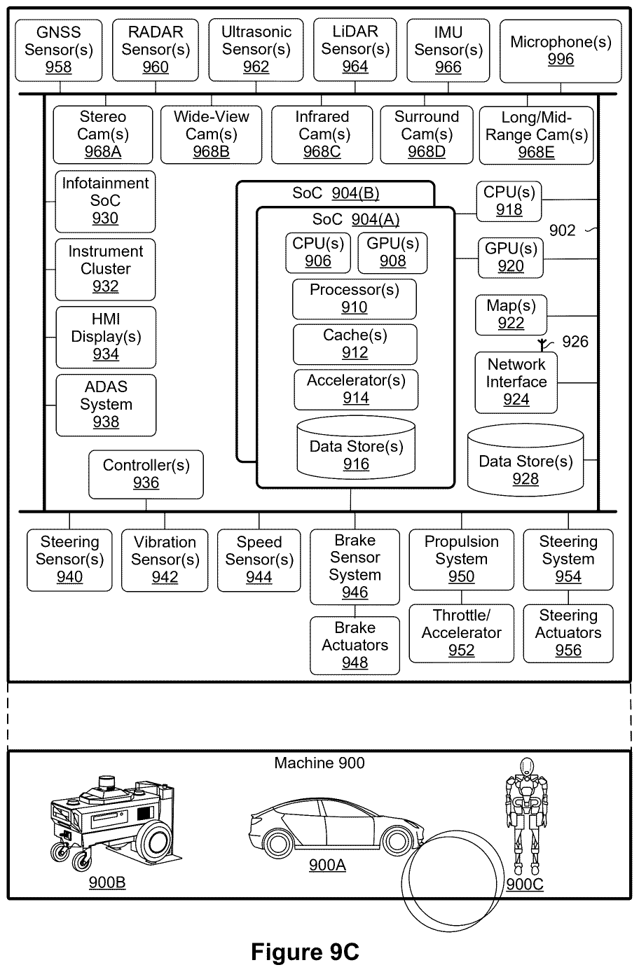

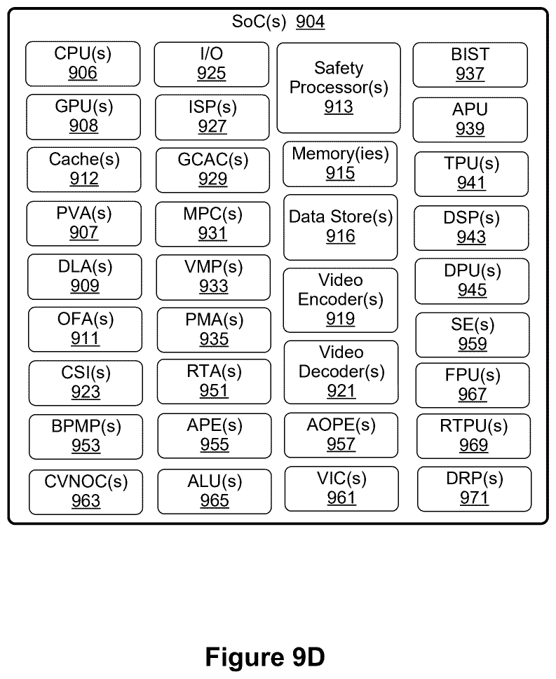

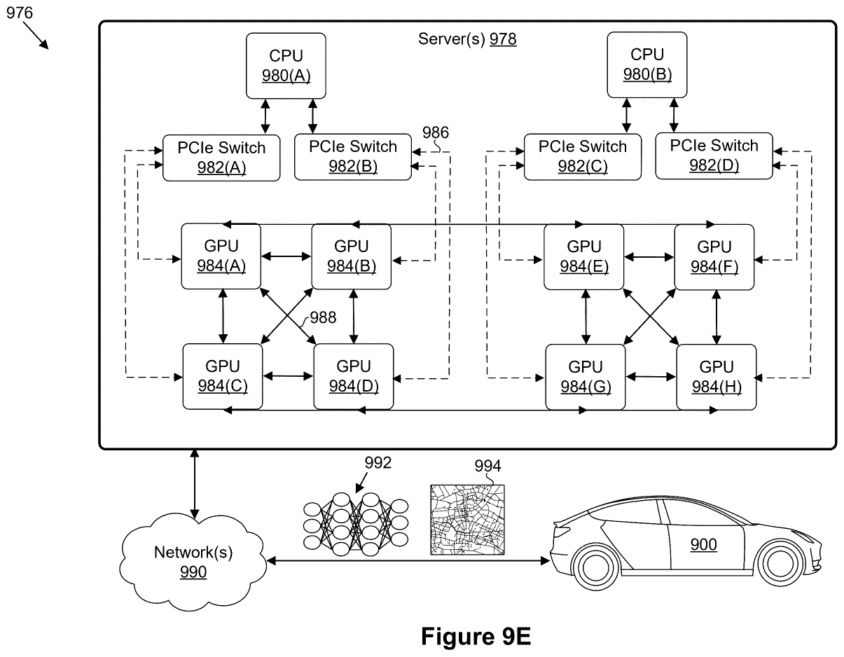

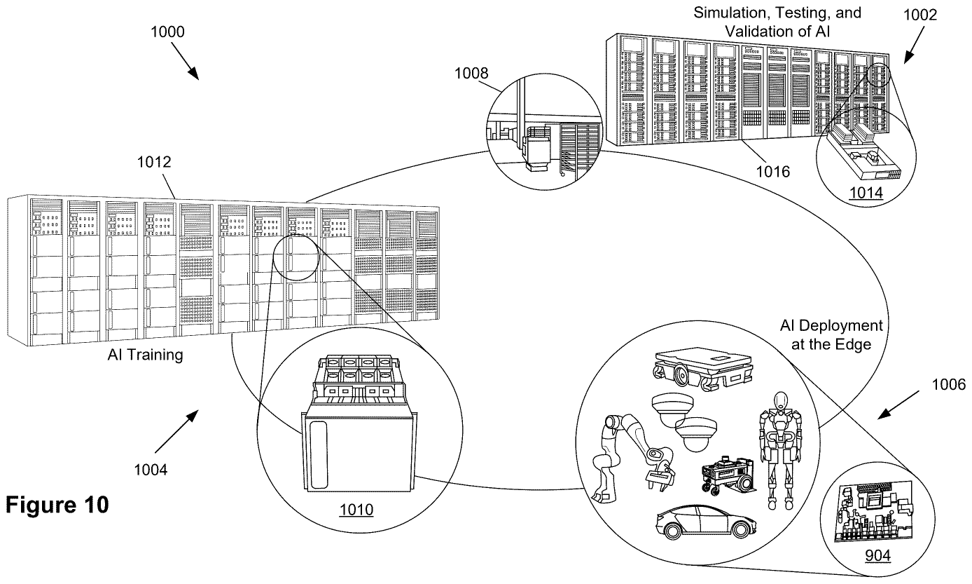

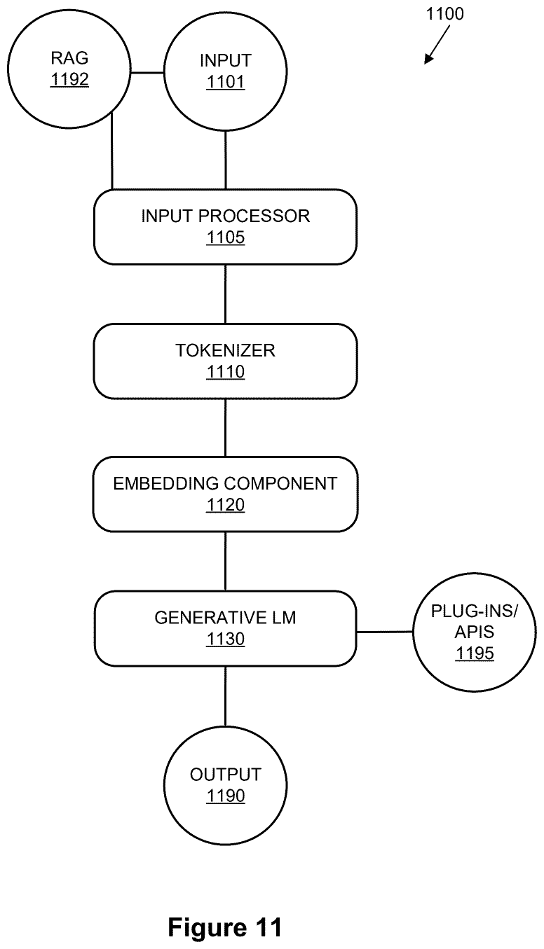

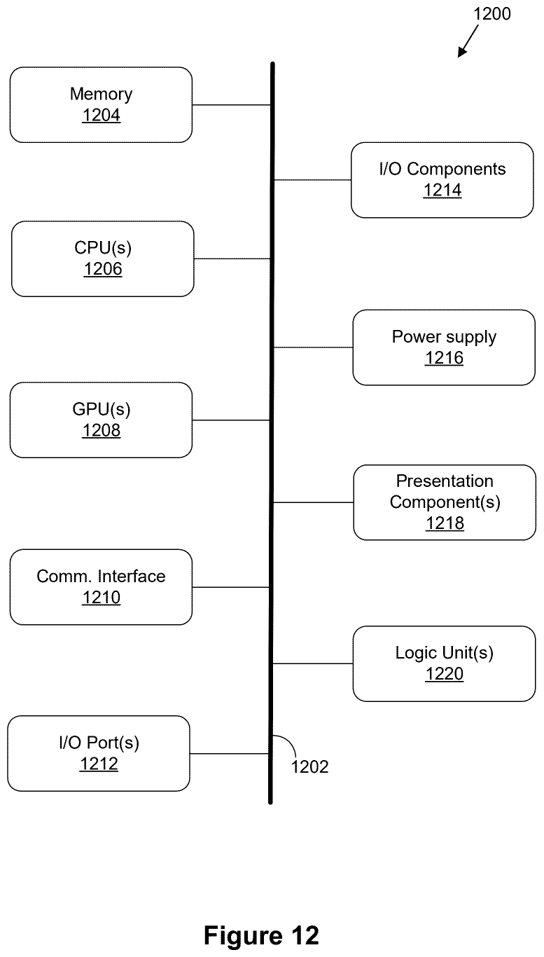

Although the present disclosure may be described with respect to an example autonomous or semi-autonomous vehicle, robot, and/or other machine type 900 (alternatively referred to herein as “vehicle 900,” “ego-vehicle 900,” “machine 900,” “ego-machine 900,” “robot 900,” and/or “ego-robot 900,” an example of which is described with respect to FIGS. 9A-9E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to target object and feature mining, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where target object and feature mining may be used. In some embodiments, the systems, methods, and/or processes described herein may be executed using similar components, features, and/or functionality to those of example machine 900 of FIGS. 9A-9E, example computing ecosystem 1000 of FIG. 10, example generative language model system 1100 of FIG. 11, and/or example computing device 1200 of FIG. 12.

In addition, although the present disclosure may be described with respect to example roadways and powered vehicles operating on those roadways, the environment in which the present disclosure may have effect is not to limited. For example, the systems and methods described herein may be used in, without limitation, environments besides roadways (including but not limited to airways or waterways). The roadway environment referred to herein is not limited to what is shown in the figures. Any type of road or street (including but not limited to one-way residential streets, residential streets with one or more than one lane in opposite directions, one-way urban streets, urban streets with one or more than one lane in opposite directions, highways, freeways, motorways, and/or other surfaces on which a powered vehicle may travel).

As discussed herein, ego machines tend to navigate using complex integrations across multiple navigation modules related to perception, planning, control, prediction, safety, and/or other tasks. These navigation modules are associated with a number of drawbacks, including (but not limited to) propagation of errors across modules that lead to reduced navigation performance, a lack of holistic understanding that interferes with the ability to make contextually aware decisions, significant re-engineering and/or adjustment of individual modules to adapt the navigation system to new tasks and/or environments, and/or redundant and/or sequential processing across modules that negatively impacts the use of the navigation systems in real-time and/or time-sensitive applications.

There is a practically limitless number of scenarios that an ego machine may encounter during travel. Training the one or more machine learning systems involves approaching that limitless number of scenarios to the extent practicable. Having a wide range of scenarios, with a wide range of variants, as inputs to the one or more machine learning systems, facilitates the one or more machine learning systems recognizing newly-encountered scenarios as having one or more characteristics of the training scenarios.

To address the above limitations, according to one aspect the disclosed systems and methods train and execute one or more machine learning systems by generating a large number of scenarios in which an ego machine may operate relative to one or more agent machines or machines, and/or to one or more objects, and/or to one or more occlusions (which may prevent an ego machine from recognizing objects ahead). The scenarios rely on inputs such as (but not limited to) camera images, other sensor data types (e.g., RADAR, LiDAR, ultrasonic, etc.), velocities, and/or global guidance to outputs such as (but not limited to) semantic segmentations, paths, and/or navigation commands.

The disclosed systems and methods include a data-generation pipeline that defines scenarios for the purpose of training one or more machine learning models, other types of machine learning models that can be used by ego machines and/or other machine types to perform tasks, hardware configurations for the machines, and/or other components of the machines. The data-generation pipeline may include a simulator that performs various types of simulations related to a machine (e.g., an ego machine) navigating within an environment (e.g., a roadway). Data generated by the simulator based on the simulations includes (but is not limited to) rendered images of the environment around the machine (e.g., from the perspective of one or more cameras on the machine and/or a birds-eye visualization), semantic labels (e.g., segmentation maps, detected objects, bounding shapes, etc.) associated with the images, a state of the machine (e.g., position, heading, velocity, etc.), and/or a map of free and/or occupied space within the environment. The data-generation pipeline may include a scenario generator that determines a goal within the map, such as (but not limited to) a target location to navigate to within the environment.

The data-generation pipeline may include a planner that generates a command to the machine to take an action related to the goal, such as a linear and/or angular velocity that moves the machine toward the goal. The command is sent to the simulator, which updates the state of the machine, rendered images, semantic labels, map, and/or other data based on the action. The simulator may send some or all of the updated data to the planner to allow the planner to generate a new command based on the updated data and the scenario from the scenario generator. This process may repeat until the machine completes the scenario, a certain number of time steps (object spans) have been executed, and/or another condition indicating the end of the simulation is met.

The data-generation pipeline may include a logger that records and synchronizes data outputted by the other components across time steps. For example, the logger may log data from the other components in the order in which the corresponding events occur within the simulation. The logger may also downsample some or all of the data (e.g., on a spatial and/or temporal basis) to reduce the size of the logged data.

A post-processor in the data-generation pipeline may adapt the generated data to various machine learning models and/or use cases. For example, the post-processor may resample, compress, format, and/or otherwise convert the generated data into a form that can be used to train and/or evaluate a machine learning model, hardware configuration, and/or other components of the machine.

The data-generation pipeline can be configured and/or customized via one or more sets of configuration parameters. For example, the configuration parameters may include a unique name and/or identifier for a given scenario (e.g., a combination of a particular environment, machine, scenario, etc.) under which data is to be generated and collected. The configuration parameters may also be used to customize the environment and/or scenario to be generated, the type of planner, the type of data to log, the frequency with which the data is logged, and/or the way in which the logged data is converted into a format that is suitable for training and/or evaluating a machine learning model and/or another component of the machine. Different sets of configuration parameters can be used to launch different instances of the data-generation pipeline (e.g., in parallel on multiple nodes of a distributed system) to generate data that captures different scenarios related to navigation and/or other types of tasks performed by machines in environments.

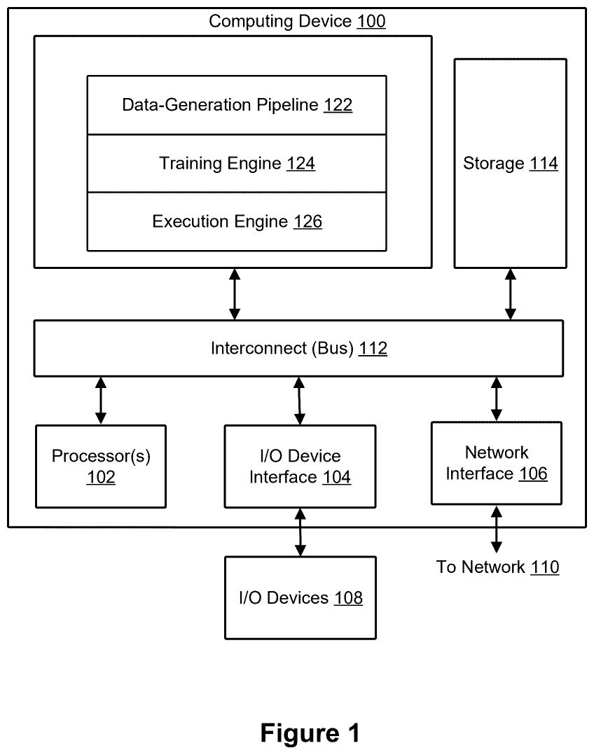

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine- or a combination of server machines—operating in a data center(s) or a cloud computing environment that provides scalable computing resources as a service over a network.

It is noted that the computing device described herein is illustrative and that any other technically feasible configurations fall within the scope of the present disclosure. For example, multiple instances of data-generation engine 122, training engine 124, and execution engine 126 could execute on a set of nodes in a distributed and/or cloud computing system to implement the functionality of computing device 100. In another example, data-generation engine 122 and training engine 124 could execute on various sets of hardware, types of devices, or environments to adapt data-generation engine 122 or training engine 124 to different use cases or applications. In a third example, data-generation engine 122 and training engine 124 could execute on different computing devices and/or different sets of computing devices.

In one embodiment, computing device 100 may include, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 may be configured to couple computing device 100 to a network 110.

Network 110 may be any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 may include non-volatile storage for applications and data, and may include fixed or removable disk drives, flash memory devices, and CD-ROM, DVD-ROM, Blu-Ray, HD-DVD, or other magnetic, optical, or solid-state storage devices. Data-generation engine 122, training engine 124, and execution engine 126 may be stored in storage 114 and loaded into memory 116 when executed.

Memory 116 may include a random-access memory (RAM) module, a flash memory unit, or any other type of memory unit or combination thereof. Processor(s) 102, I/O device interface 104, and network interface 106 may be configured to read data from and write data to memory 116. Memory 116 may include various software programs that can be executed by processor(s) 102 and application data associated with said software programs, including data-generation engine 122, training engine 124, and execution engine 126.

In some embodiments, training engine 124 trains one or more machine learning systems to define additional scenarios. In some embodiments, training engine 124 and execution engine 126 include functionality to train and execute one or more machine learning systems to enable a vehicle to recognize and react appropriately to a very large number of scenarios to navigate roadways safely and successfully. The one or more machine learning systems map, directly or otherwise, inputs such as (but not limited to) camera images, velocities, global guidance, and/or vehicle states to multimodal outputs such as (but not limited to) semantic segmentations, paths, and/or navigation commands. These multimodal outputs can then be used to perform navigation for the vehicle, generate predictions of future states associated with the vehicle, simulate operation of the vehicle, and/or perform other tasks related to the vehicle. Training engine 124 and execution engine 126 are described in further detail herein.

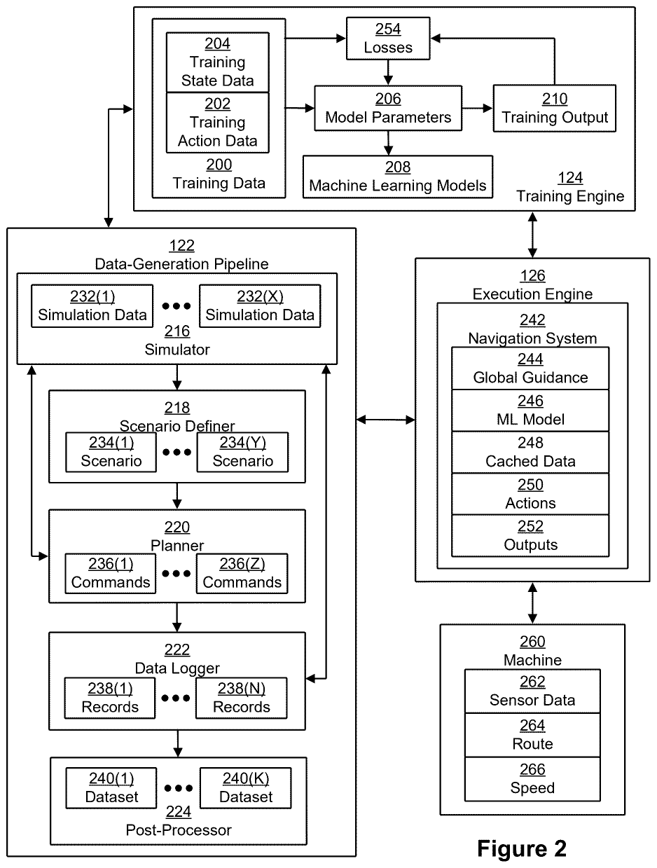

In some embodiments, data-generation pipeline 122 defines scenarios for the purpose of training, evaluating, and/or testing a vehicle, robot, or other machine, other types of machine learning models that can be used by various machine types to perform tasks, hardware configurations for the vehicles, and/or other components of the vehicles. As discussed herein, data-generation pipeline 122 may be configured and/or customized via various parameters to generate data that captures different scenarios related to navigation and/or other types of tasks performed by machines in environments. Data-generation pipeline 122 is described in further detail herein with respect to FIGS. 2 and 6-8.

It should be understood that the arrangement of FIG. 1, and of other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises-such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 900 of FIGS. 9A-9E, example computing ecosystem 1000 of FIG. 10, example generative language model system 1100 of FIG. 11, and/or example computing device 1200 of FIG. 12.

FIG. 2 illustrates a system for performing end-to-end navigation that includes data-generation pipeline 122, training engine 124, and execution engine 126 of FIG. 1, according to various embodiments. As discussed herein, data-generation pipeline 122 defines scenarios that can be used to train, evaluate, test, and/or otherwise operate a multimodal navigation system 242, other types of machine learning models that can be used by various machine types to perform tasks, hardware configurations for the machines, and/or other components of the machines.

Data-generation pipeline 122 includes a simulator 216 that generates multiple sets of simulation data 232(1)-232(X) (each of which is referred to individually herein as simulation data 232). For example, simulator 216 may perform physics simulations of various environments around various types of machines. During these physics simulations, simulator 216 may generate simulation data 232 that includes (but is not limited to) rendered images of the environment around the machine (e.g., from the perspective of one or more cameras on the machine and/or a birds-eye visualization), semantic labels (e.g., segmentation maps, detected objects, bounding shapes, etc.) associated with the images, a state of the machine (e.g., position, heading, velocity, etc.), and/or a map of free and/or occupied space within the environment.

Data-generation pipeline 122 includes a scenario definer 218 that determines a set of scenarios 234(1)-234(Y) (each of which is referred to individually herein as scenario 234) associated with simulation data 232. For example, scenario definer 218 may define, within a given map outputted by simulator 216, a route for a vehicle to navigate in the midst of traffic, in the presence of one or more objects or occlusions within an environment. The environment is not limited to particular weather or daylight conditions, but may include various conditions that may have an impact on a vehicle's navigation (including but not limited to dawn, day, dusk, night, sun, clouds, temperature, wind, fog, rain, freezing rain, snow, sleet, and/or hail).

Data-generation pipeline 122 includes a planner 220 that generates various commands 236(1)-236(Z) that cause the machine to take one or more corresponding actions based on simulation data 232 and/or scenarios 234. For example, planner 220 may generate commands 236 that include (but are not limited to) a linear and/or angular velocity that move the vehicle along a certain scenario 234 from scenario definer 218 while avoiding objects in an environment represented by simulation data 232 from simulator 216, or from the scenario 234 itself.

Each set of commands 236 outputted by planner 220 may be sent to simulator 216, which updates the state of the machine, rendered images, semantic labels, map, and/or other simulation data 232 based on the action. Simulator 216 may then send some or all of the updated simulation data 232 to planner 220 to allow planner 220 to generate a new set of commands 236 based on the updated simulation data 232 and the corresponding scenario 234 from scenario definer 218. This process may repeat until scenario 234 is reached, a certain number of time steps or iterations has been executed within a given simulation, and/or another condition indicating the end of the simulation is met.

Data-generation pipeline 122 further includes a data logger 222 that aggregates simulation data 232, scenarios 234, commands 236, and/or other data generated by simulator 216, scenario definer 218, and planner 220 into multiple records 238(1)-238(N) (each of which is referred to individually herein as record 238). For example, data logger 222 may log, in records 238, data from simulator 216, scenario definer 218, and/or planner 220 in the order in which the corresponding events occur (e.g., in time steps, “frames” of simulation data 232, and/or other discrete representations of time) within the corresponding simulations. Data logger 222 may also, or instead, downsample and/or resample some or all of the data (e.g., on a spatial and/or temporal basis) in records 238 to reduce and/or modify the size of the logged data.

A post-processor 224 in data-generation pipeline 122 adapts simulation data 232, scenarios 234, commands 236, records 238, and/or other data generated by the other components of data-generation pipeline 122 to various machine learning models and/or use cases. For example, post-processor 224 may resample, compress, format, and/or otherwise convert data in a given set of records 238 into a form that can be used to train and/or evaluate a machine learning model, hardware configuration, and/or other components of one or more machines. Each set of records 238 that is post-processed for a given purpose and/or in a certain way may be stored in one or more datasets 240(1)-240(K) (each of which is referred to individually herein as dataset 240) for subsequent retrieval and use.

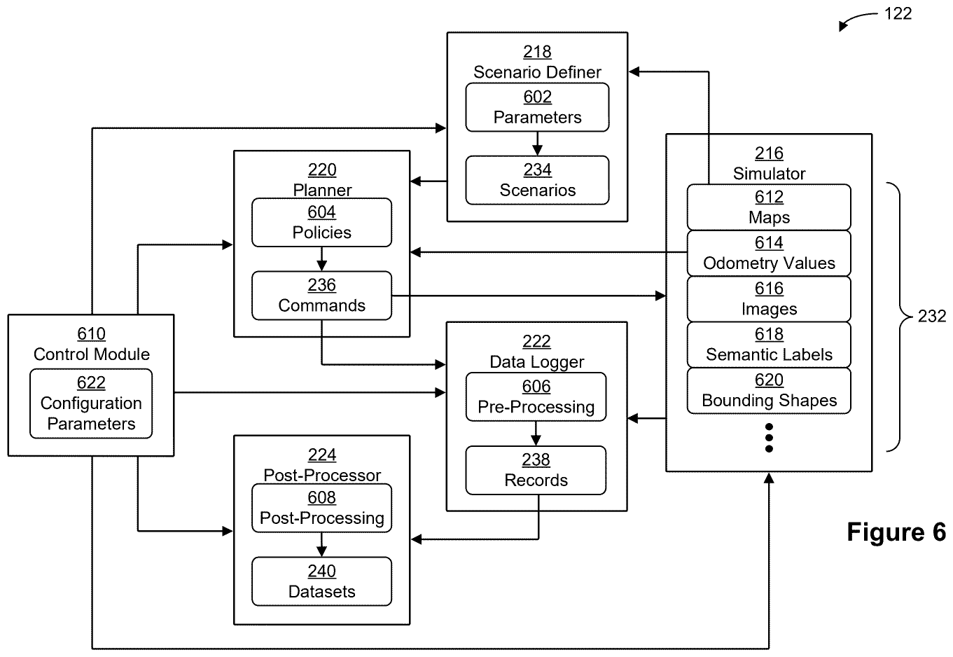

In some embodiments, data-generation pipeline 122 is configured and/or customized via different types of configuration parameters. For example, the configuration parameters may include a unique name and/or identifier for a given scenario (e.g., a combination of a particular environment, machine, scenario, etc.) under which data is to be generated and collected. The configuration parameters may also be used to customize the environment and/or the scenario, the type of planner, the type of data to log, the frequency with which the data is logged, and/or the way in which the logged data is converted into a format that is suitable for training and/or evaluating a machine learning model and/or another component of the machine. Different sets of configuration parameters can be used to launch different instances of the data-generation pipeline (e.g., in parallel on multiple nodes of a distributed system) to generate data that captures different scenarios related to navigation and/or other types of tasks performed by machines in environments. Data-generation pipeline 122 is described in further detail with respect to FIGS. 6-8.

Training engine 124 trains one or more machine learning models 208 using training data 200 that is derived from one or more datasets 240 generated by data-generation pipeline 122, data collected by machines in real-world environments, simulation using, for example, the simulator 216, and/or other data sources. In some embodiments, training engine 124 trains the one or more machine learning models 208 to define additional scenarios. In some embodiments, datasets 240 may include large numbers of scenarios described herein. As shown in FIG. 2, training data 200 includes training state data 204 representing states associated with machines and/or environments. For example, training state data 204 may include sensor data (e.g., images, LiDAR, RADAR, audio data, ultrasonic data, inertial measurement unit (IMU) data, etc.) captured by virtual and/or real sensors on the machines, representations of environments around the machines (e.g., visualizations, semantic segmentations, point clouds, meshes, environment types, environment descriptions, scene description using Universal Scene Descriptor (USD) data (e.g., OpenUSD), etc.), linear and/or angular velocities of the machines, machine types and/or machine models associated with the machines, global guidance associated with navigation and/or other tasks or scenarios 234 of the machines, and/or other information that can be used to characterize the states of the machines and/or environments around the machines.

Training data 200 also includes training action data 202 representing actions to be performed by machines in environments. For example, training action data 202 may include “ground truth” actions, action policies, commands, routes, trajectories, linear velocity, angular velocity, paths, and/or other indications of actions to be performed during perception, planning, control, prediction, navigation, manipulation, and/or other tasks using the machines.

In some embodiments, machine learning models 208 are used to perform and/or guide tasks using the machines. Although examples may be described herein with respect to using machine learning models, such as neural networks, this is not intended to be limiting. For example, and without limitation, machine learning models 208 may include any of the various machine learning models and/or neural networks described herein, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

Machine learning models 208 may also, or instead, include rules, filters, heuristics, logic programming, semantic nets, search techniques, named entity recognition techniques, and/or other symbolic models. Each machine learning model may be used to generate embeddings, semantic segmentations, reconstructions and/or predictions of sensor data, classification output, safety alerts, trajectories, commands, and/or other output related to one or more corresponding tasks.

During training of machine learning models 208, training engine 124 inputs some or all training state data 204 into machine learning models 208. Training engine 124 uses model parameters 206 (e.g., neural network weights) of machine learning models 208 to process the inputted training state data 204 and obtains training output 210 that includes predictions associated with training state data 204 from one or more layers, blocks, or components of machine learning models 208. Training engine 124 computes one or more losses 254 using training output 210, training state data 204, and/or training action data 202. Training engine 124 then uses a training technique (e.g., gradient descent and backpropagation) to iteratively update model parameters 206 of machine learning models 208 in a way that reduces losses 254.

In one or more embodiments, execution engine 126 uses some or all trained machine learning models 208 to implement a navigation system 242 that can be used to perform navigation and/or other tasks for a machine 260 in a real-world, simulated, digital twin, and/or another type of environment. Machine 260 may include an autonomous or semi-autonomous vehicle, drone, submarine, watercraft, and/or another type of vehicle with navigation capabilities. Navigation system 242 may be deployed for real-time inference on machine 260 using a runtime platform (e.g., NVIDIA's TensorRT) that accelerates and optimizes performance using quantization, layer and tension fusion, kernel tuning, GPU-based execution, streaming audio and/or video, and/or concurrent execution.

Navigation system 242 operates on inputs such as (but not limited to) sensor data 262 from machine 260 (e.g., camera images, LiDAR data, RADAR data, audio data, velocities, states, etc.), route data 264 associated with the tasks (e.g., paths, trajectories, routes, destinations, etc.), speed data 266 (e.g., relative speeds, acceleration, and/or deceleration of the ego machine or the agent machine(s)) and/or other representations of machine 260 and/or the environment around machine 260.

In some embodiments, different scenarios may be created from different combinations of filtering functions of object spans, each of which can be a building block for creating scenarios to be mined. Multiple ones of these filtering functions can be joined in a number of ways to produce one or more output objects from an input object, and thereby produce additional scenarios. An exemplary but by no means exhaustive list of filtering functions may include:
Filtering of an object span to determine whether the span satisfies one or more criteria, and remove or keep the span as a whole. An exemplary but by no means exhaustive list of filters may include:
   object heading
   dimension (span size)
   average object speed
   average ego speed
   object class (including, for example, one or a group of pedestrians or bicyclists which may be pushing or pulling another object (in the case of pedestrians, pushing a stroller, and in the case of bicyclists, pulling a trailer), or one or a group of powered vehicles—including, for example, a car, bus, train, tram car, small or large truck (with or without trailer), motorcycle, or other powered wheeled vehicle)
   duration
   objects (for example, a combination of one or more of the filtering criteria listed herein)
   ego travel direction—for example, curved trajectory or straight, object or ego travel distance, possibly including deviation from trajectory
   ego or agent machine travel distance
   satisfaction of a relationship (keep span if satisfied, otherwise discard the span)
   occlusions (where the ego machine may be blocked or occluded by other objects—for example, one or more parked agent machines, or multiple agent machines moving ahead of the ego machine)
   duplicates
   passing lines (where a line may define a separation between an ego machine and an agent machine, and in some cases may include a lane divider)
   passing polygons (where a polygon, whether convex or non-convex, may define a part of an environment in which a vehicle travels); passing polygons means that a vehicle is traveling through multiple polygons
   ego lateral velocity
cropping of an object span based on specified criteria, to keep portions of the span. An exemplary but by no means exhaustive list of cropping criteria may include one or more of the filter criteria listed herein, as well as:
   ego longitudinal velocity
   ego trajectory curvature (ego machine traveling left or right)
   overlap with another span
   presence of an occlusion
   time interval(s)
   spans—for example, timely overlap between source and target object spans
   portions of spans visible to a front camera of the ego machine
extending an object span by time-for example, if the span duration is too short—or object travel distance, in either a forward or backward direction.
aggregating or clustering multiple object spans—for example, where multiple object spans overlap in time, they may be aggregated into a single span, or clustered into a list of spans. As another example, for multiple span lists, aggregating spans, one from each list, that overlap with each other geometrically.

In some embodiments, a scenario may be compiled with some or all of the following list of information (the list being exemplary but by no means exhaustive):
A list of objects;
Track information for each object, including dimension, position, orientation, and position relative to an ego machine;
Scenario start time and end time;
Scenario start scene and end scene, each of which may be derived from an index corresponding to a frame number for a sensor on the ego machine, such as LiDAR or RADAR;
A ticket content to enable human labeling of the scenario;
Links to different video cameras on different parts of the ego machine—for example, left, right, front, and rear—with different fields of view

In some embodiments, an object-centric mining library may be compiled, based on different scenario descriptions using one or more of the following:
Object classes
Distances between ego machine and object(s)
Speeds of ego machine and object(s)
Relative speeds of ego machine and object(s)
Acceleration of ego machine and object(s)
Relative acceleration between ego machine and object(s)
Occlusion information
Trajectory curvature
Spatial relationship between ego machine and object(s)

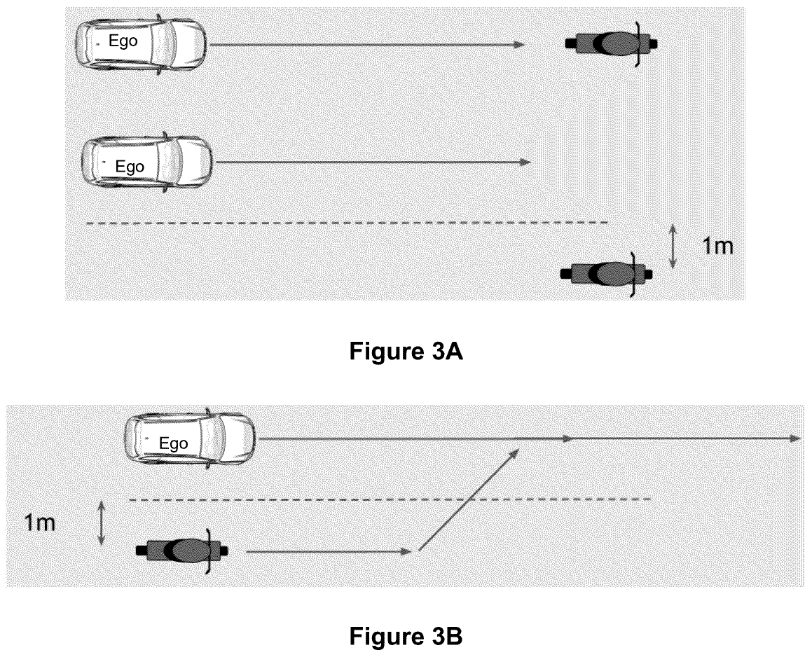

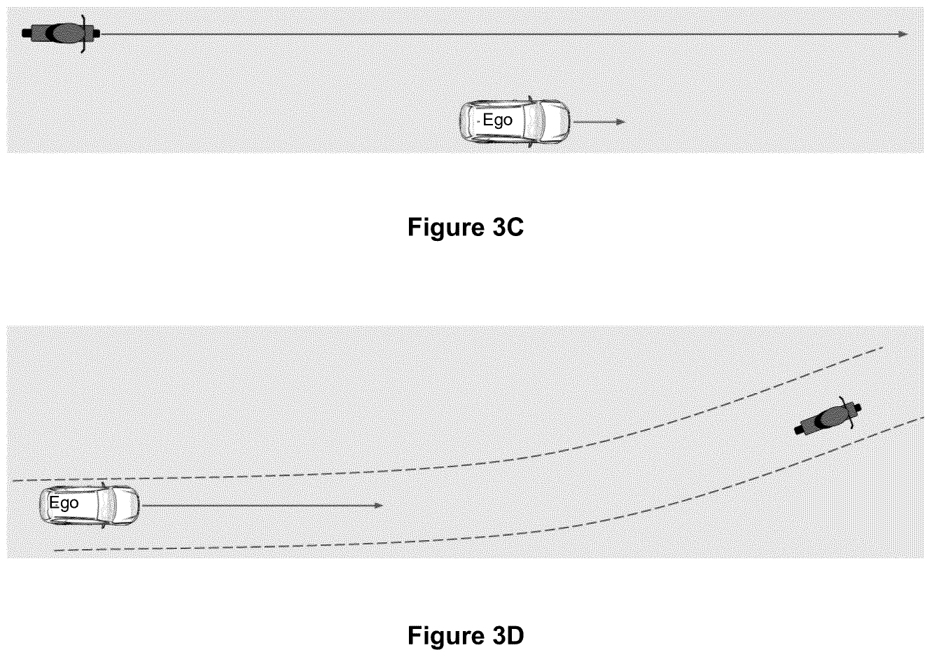

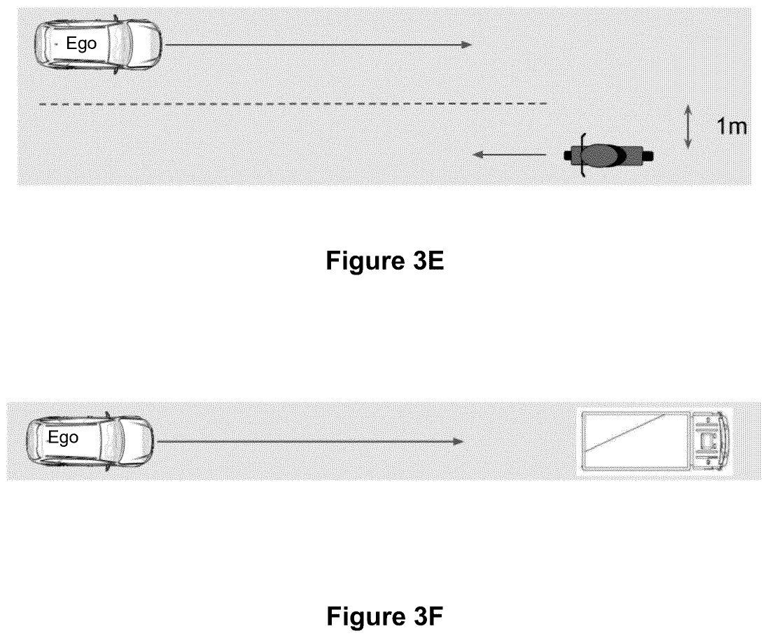

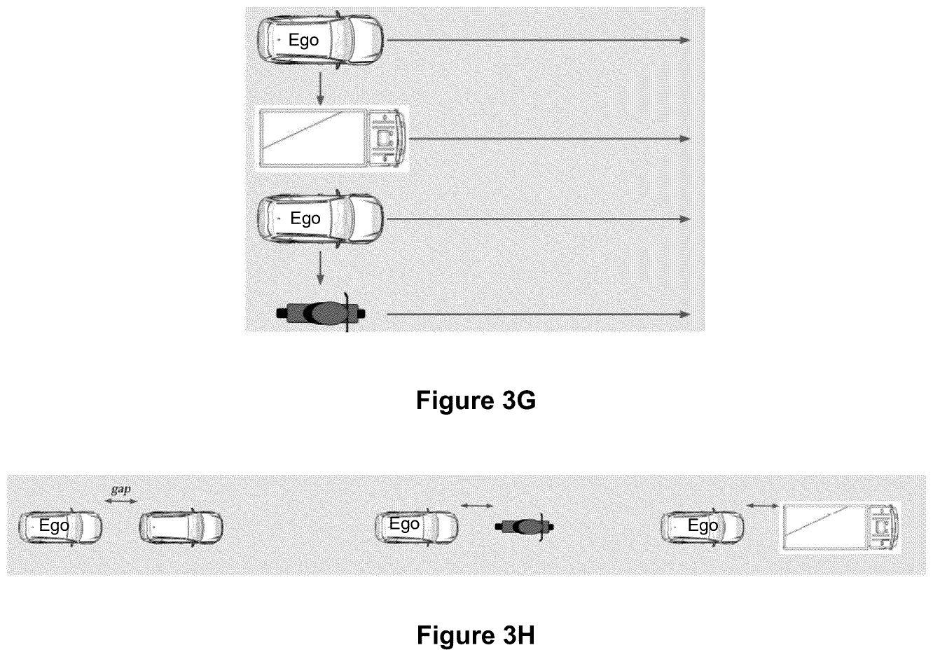

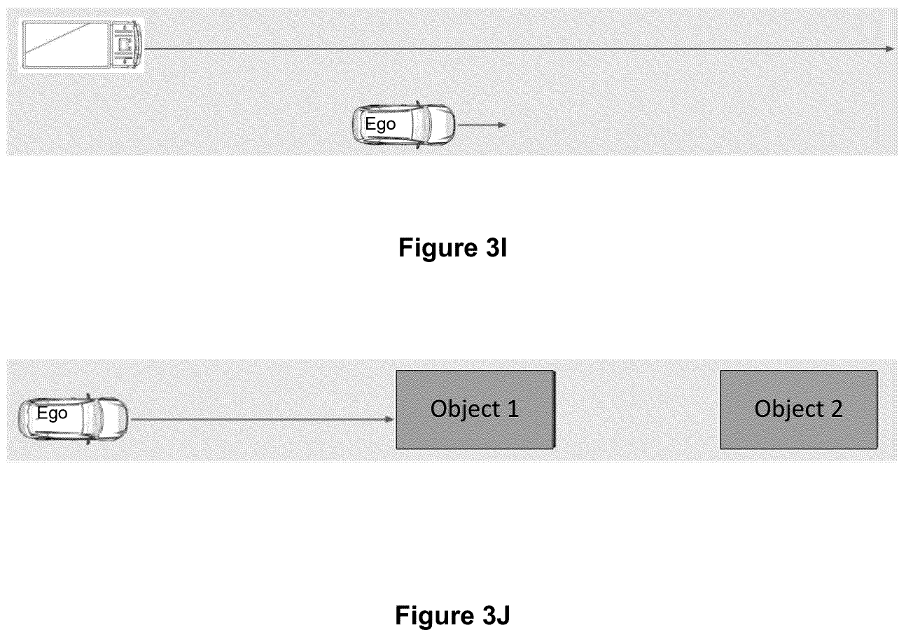

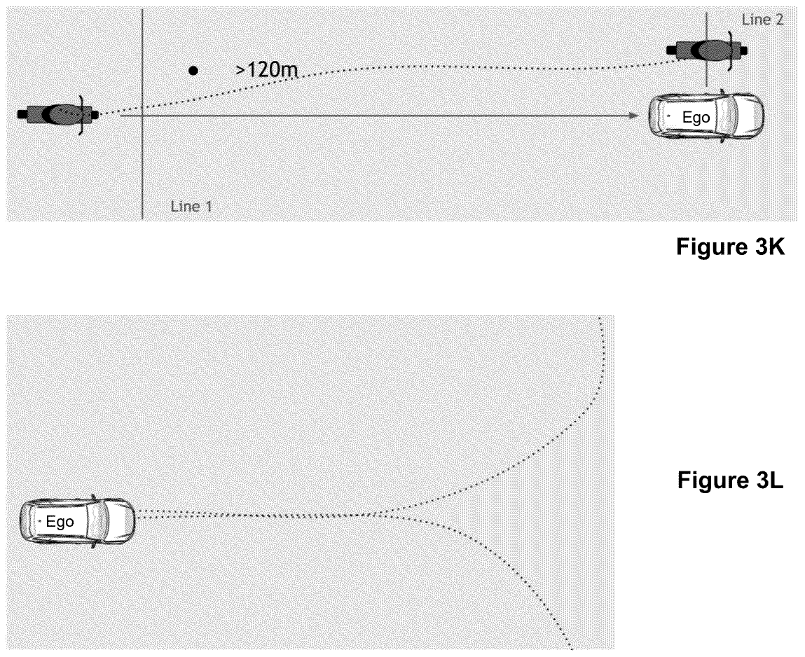

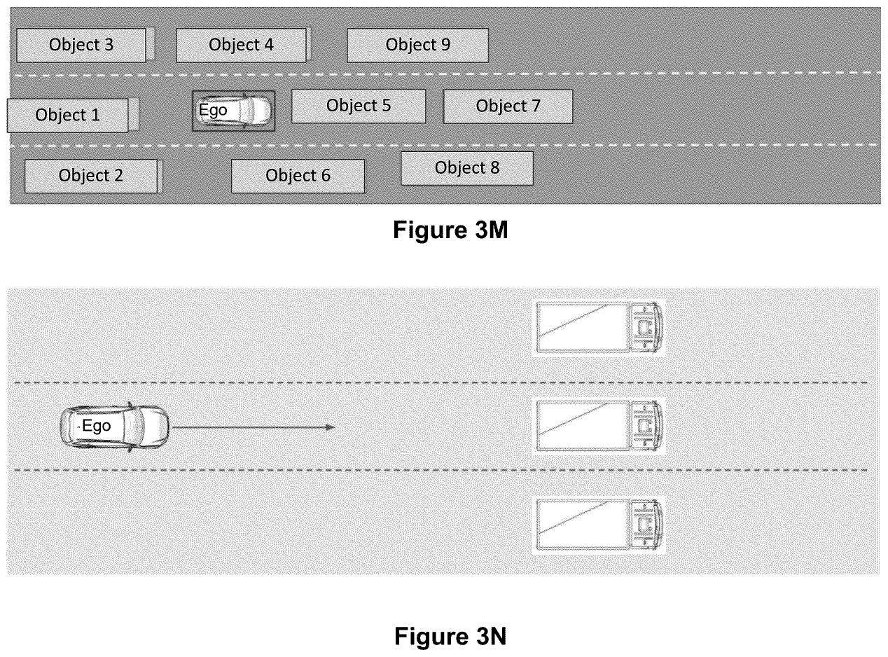

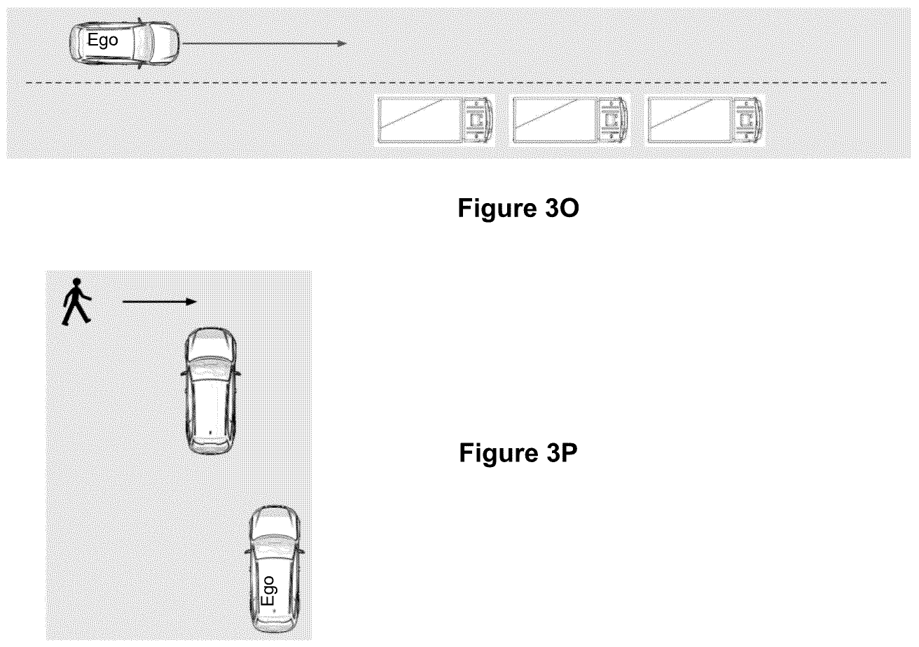

In the following discussion of different scenarios shown in FIGS. 3A-3P, ordinarily skilled artisans will appreciate that these scenarios are exemplary, and that a number of variations of these scenarios also may be mined. Different measurement units may be used in different sets of scenarios, for ease of understanding. The embodiments being described are not limited to particular measurement units. Sometimes the metric system may be employed; sometimes the English system may be employed.

Also, in order to enlarge a set of scenarios, lighting, weather, and road conditions may be varied, so that the ego machine and agent machine(s) may be traveling in weather that may be sunny, cloudy, rainy, snowy, windy, or foggy. The ego machine and agent machine(s) may be traveling at night, during the day, or at dawn or dusk. The road may be dry or slippery (because of rain, snow, or ice, for example). Darkness (including lack of road lighting), slick roads, high winds, and/or foggy conditions may cause the ego machine and agent machine(s) to travel more slowly than under normal conditions.

Agent machines may be of different types. A non-limiting list of agent machine types may include a passenger vehicle, such as a car, a shuttle, a pickup truck, a van, a minivan, a limousine, a sport utility vehicle, a bus, a tram car, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a semi truck, or a semi truck coupled to one or more trailers. Varying the agent machine types may enable enlarging a given set of scenarios. In addition, ego machines may be of the different types, as described herein with respect to agent machines. A non-limiting list of ego machine types may include a passenger vehicle, such as a car, a shuttle, a pickup truck, a van, a minivan, a limousine, a sport utility vehicle, a bus, a tram car, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a semi truck, or a semi truck coupled to one or more trailers.

Ordinarily skilled artisans will appreciate that the different scenarios being described are exemplary, and are not exhaustive. Variations may be derived from the scenario descriptions herein.

### Straight Line Constant Velocity

In this set of scenarios, as depicted in FIG. 3A, an ego machine and an agent machine may be in the same lane, or may be in adjacent lanes. In one example scenario, the ego machine may be traveling in a particular direction at a particular speed, at a particular distance from the agent machine. Varying the distances between the vehicles, and/or the speeds at which the vehicles are traveling, enlarges the number of this type of scenario.

### Lane Change/Cut-In

In this set of scenarios, as depicted in FIG. 3B, an agent machine may change lanes in front of an ego machine, to go into the same lane as the ego machine. The distance in front of the ego machine, at which the agent machine cuts into the ego machine's lane, may be varied from a relatively gentle maneuver at a longer distance ahead of the ego machine, to a relatively aggressive maneuver at a closer distance to the ego machine. The aggressive maneuver may simulate a move by an agent machine in heavy traffic. In FIG. 3B, the length of the diagonal line between the agent machine and the ego machine may signify the aggressiveness of the agent machine's cutting in. A shorter line would signify a more aggressive cut-in. A longer line would signify a less aggressive (more gradual) cut-in.

Varying the relative speeds of the agent machine and the ego machine, and/or the distances between the ego machine and agent machine at cut-in, and/or relative trajectories of the agent machine and the ego machine (e.g. straight road, gently curved road, steeply curved road), enlarges the number of this type of scenario.

In some embodiments, one agent machine may cut in front of another agent machine, where the relative speeds, relative distances, and relative trajectories for the two agent machines may be mined similarly to the ego machine/agent machine cut-in situation, to enlarge the number of this type of scenario even more.

### Acceleration During Overtake by Lighter Agent Machine

In this set of scenarios, as depicted in FIG. 3C, an agent machine, for example a motorcycle, may overtake a heavier ego machine, for example a truck or van, at different relative speeds, with the agent machine accelerating at different rates to overtake the ego machine from an adjacent lane. The ego machine may be stationary, or may be in motion. The agent machine may begin at rest, and may be at different distances from the ego machine at the start of the maneuver. Varying the absolute and relative velocities of the ego machine and the agent machine, and/or the relative trajectories of the agent machine and ego machine as discussed herein, enlarges the number of this type of scenario.

### Curved Road Constant Velocity

In this set of scenarios, as depicted in FIG. 3D, the trajectory curvature of the ego machine may be varied, along with its speed going through the curve, as the ego machine trails an agent machine. Varying the tightness of the curve, the speeds going into, through, and out of the curve, different initial and relative speeds between the ego machine and the agent machine and initial and/or relative distances between the ego machine and the agent machine, enlarges the number of this type of scenario.

### Oncoming Vulnerable Road User (VRU)

In this set of scenarios, as depicted in FIG. 3E, an agent machine may be proceeding in an opposite direction from the ego machine, and may be considered vulnerable relative to the ego machine. For example, the ego machine may be a car or van, and the agent machine may be a motorcycle or bicycle. Varying the velocities of the ego machine and agent machine in opposite directions, and/or the relative positions of the ego machine and agent machine in their respective lanes, enlarges the number of this type of scenario.

### Hard Deceleration

In this set of scenarios, as depicted in FIG. 3F, an agent machine may be proceeding ahead of the ego machine, in the same lane, at different speeds, and/or at different distances from each other. The agent machine may decelerate at different rates, representing different braking maneuvers, from slow, to normal, to rapid deceleration. The goal is to avoid a collision between the ego machine and the agent machine. In some embodiments, a sufficient distance between the ego machine and the agent machine may be assumed in order to ensure the ego machine's safety. Varying the speeds of the ego and agent machines, their relative distances, and/or the degree of braking of the agent machine, enlarges the number of this type of scenario.

### 90 Degree Stagnation

In this set of scenarios, as depicted in FIG. 3G, the ego machine and agent machine(s) may be stopped at the beginning, at different relative distances, in different lanes. As the ego machine and agent machine(s) proceed, an agent machine may speed up or slow down to come alongside the ego machine, so that the agent machine may be viewed at a 90 degree angle relative to the ego machine. Varying the absolute and/or relative speeds of the ego machine and the agent machine(s), and/or the absolute and/or relative positions of the vehicles in their respective lanes, enlarges the number of this type of scenario.

### Behind Stationary Target

In this set of scenarios, as depicted in FIG. 3H, there may be different gaps between an ego machine and a stationary agent machine. In some embodiments, the agent machine may be stopped to allow a pedestrian or bicycle to cross. Without limitation, the agent machine may be a motorcycle, car, motorcycle, truck, and/or van. Automatic emergency braking (AEB) may be invoked in some scenarios. Varying the speed of the ego machine, and its distance from the agent machine at the beginning of the maneuver, enlarges the number of this type of scenario.

### Acceleration During Overtake by Heavier Agent Machine

In this set of scenarios, as depicted in FIG. 3I, an agent machine may overtake an ego machine at different relative speeds. The ego machine may be stationary, or it may be moving. The agent machine may start at different distances behind the ego machine. The agent machine may or may not be in the same lane as the ego machine when starting to overtake the ego machine. The agent machine may accelerate at different rates relative to the ego machine. Varying the distances, lanes, accelerations, and/or relative speeds of the ego machine and the agent machine before and during the maneuver, enlarges the number of this type of scenario.

### Occluded Scenario

In this set of scenarios, as depicted in FIG. 3J, an ego machine may be trailing one or more agent machines, which are objects, in a given lane (ego lane). One of the agent machines may occlude another agent machine so that the ego machine can only see one of them. Varying the distance from the ego machine to one of the agent machines; the distance between agent machine(s); and/or the speeds of the ego machine and the agent machine(s), enlarges the number of this type of scenario.

### Active Lane Change Assist (ALCA) Scenario

In this set of scenarios, as depicted in FIG. 3K, an agent machine may be behind the ego machine, and may pass to one side or the other of the ego machine. The agent machine may start its passing maneuver at different distances behind the ego machine, at different relative speeds, and may cut left or right at different distances behind the ego machine. Varying these different distances, different relative speeds, and/or direction of overtake (left or right), enlarges the number of this type of scenario. In some embodiments, ALCA may include Adaptive Cruise Control (ACC) and/or Active Steering Assist (ASA).

### Ego Turning Cases

In this set of scenarios, as depicted in FIG. 3L, the ego machine may be turning left or right. A trajectory curvature for the ego machine may be used to judge a change in direction of the ego machine. In some embodiments, the ego machine may execute its turns with one or more agent machines nearby. Varying curvatures, directions, and/or lengths of curves, enlarges the number of this type of scenario.

### Stop and Go Traffic

In this set of scenarios, as depicted in FIG. 3M, the ego machine may be surrounded by a number of agent machines, which may be cars, trucks, buses, vans, motorcycles, or other road vehicles. This set of scenarios may be considered a heavy traffic, or traffic jam situation on a road or highway. Depending on the scenarios, the agent machines may number from three to nine or more. The movement of the ego machine relative to the agent machines may be varied. For example, the ego machine may proceed at the same speed as the surrounding agent machines; may accelerate to overtake an agent machine; may decelerate to put more distance between the ego machine and the agent machine; or may change lanes to cut in front of an agent machine or cut away from an agent machine. One or more of the agent machines, which also may be termed obstacle vehicles since they surround the ego machine and may limit the ego machine's movement, also can accelerate or decelerate, or change lanes to cut in front of the ego machine or cut away from the ego machine. Varying the ego machine's relative speed, acceleration, lane occupancy (including cutting in and/or cutting away), enlarges the number of this type of scenario. Similarly, varying the agent machine's relative speed, acceleration, lane occupancy (including cutting in and/or cutting away), enlarges the number of this type of scenario.

### Multiple Objects in Adjacent Lanes

In this set of scenarios, as depicted in FIG. 3N, an ego machine may be traveling in a lane on a road with more than one lane in the direction of travel. Agent machines may be ahead of the ego machine, in the same or different lanes, at different distances from the ego machine. The ego machine may be moving at the same speed as the agent machines, or may be moving more quickly or more slowly. Varying the relative distances, relative speeds, accelerations, and/or lane occupancy, enlarges the number of this type of scenario.

### Parked Vehicles

In this set of scenarios, as depicted in FIG. 3O, starts the maneuver at a particular distance from the stationary (parked) vehicles, and/or at a particular speed. The ego machine may approach one or more parked vehicles, which may vary among cars, vans, trucks, and the like. The vehicles may be parked back to back. In some embodiments, the nearest target may be the desired target type, for example, a truck. Varying initial distances at which the ego machine begins the maneuver to approach the parked vehicles, and speeds of approach of the ego machine to the target vehicles, enlarges the number of this type of scenario.

### Crossing VRU From Occlusion State

In this set of scenarios, as depicted in FIG. 3P, an ego machine may be proceeding along a road. A pedestrian, bicycle, or other vehicle as appropriate may be a target type, crossing in front of the ego machine. The ego machine may be blocked by one or more other agent machines which may be proceeding in the same direction as the ego machine, but may block (occlude) the ego machine's sight. The initial distance of the ego machine from the target type may be different. The absolute and relative speeds and/or accelerations of the ego machine and agent machine(s) may differ. Varying the initial distance, absolute and/relative speeds, and/or absolute and/or relative accelerations, enlarges the number of this type of scenario.

In all of the scenarios discussed herein, the speeds of the ego machine and target vehicle(s) may vary depending on the road type (for example, 25 miles per hour on a residential street, 35 miles per hour on a secondary arterial road, 40 or 45 miles an hour on a main arterial road, or the like. Highway or freeway speeds may be contemplated, it being borne in mind that the likelihood of a target crossing in front of the ego machine is quite low on those roads.

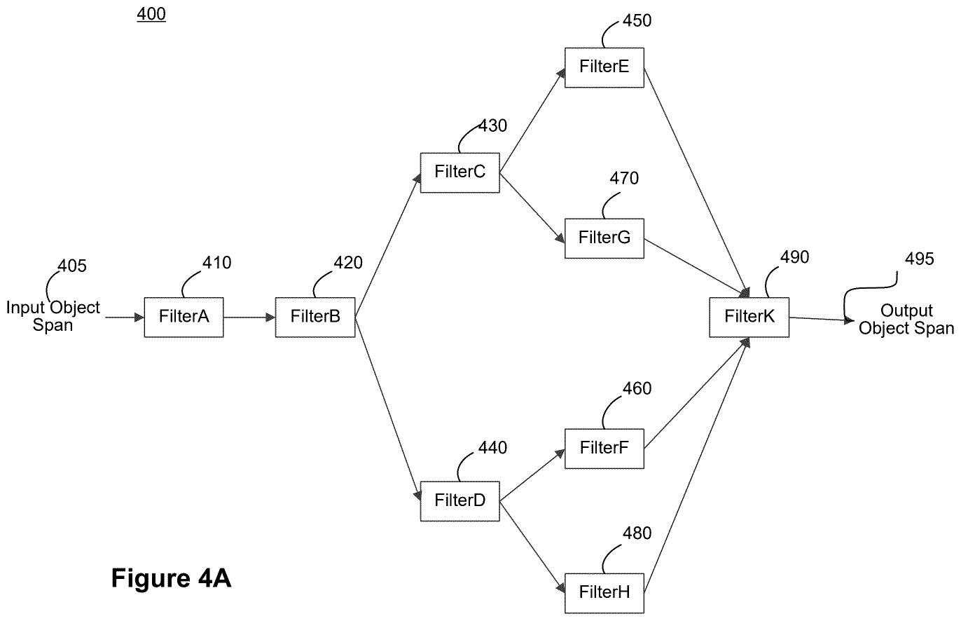

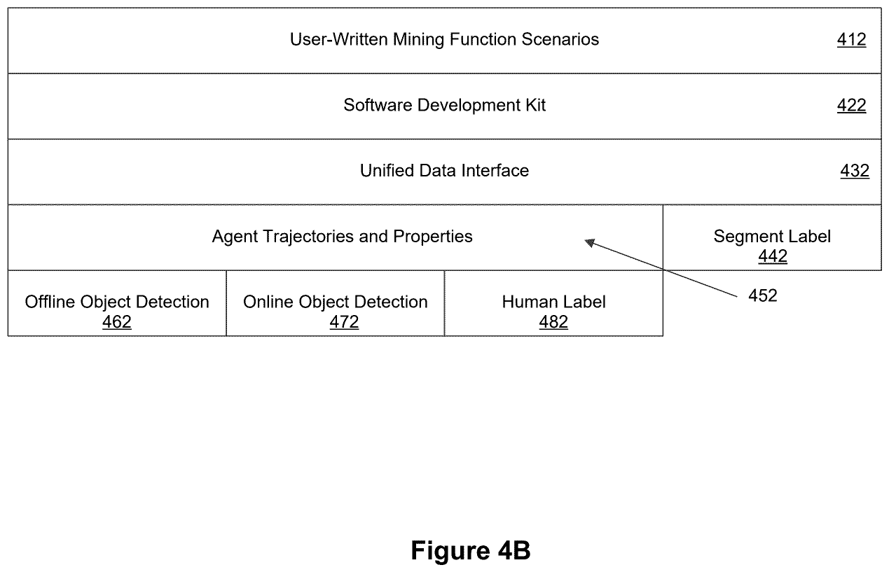

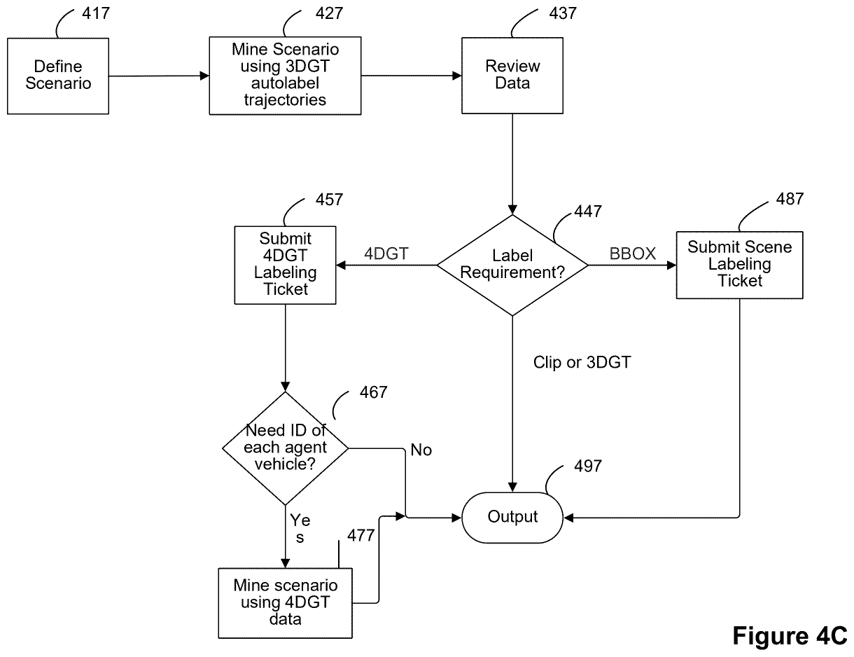

FIG. 4A shows a non-limiting example of compiling a scenario, including but not limited to the ones shown in FIGS. 3A-3P, using the filtering functions discussed herein. Depending on the scenario, and/or the relative orientations, accelerations, and/or speeds of the ego machine and agent machine(s), and/or distances between the ego machine and agent machine(s), and/or position of occlusions, in some embodiments different combinations of filter, crop, aggregate, and expand may take an input object span 405 through a sequence of filtering functions FilterA 410, FilterB 420, FilterC 430, FilterD 440, FilterE 450, FilterF 460, FilterG 470, FilterH 480, and FilterK 490 to produce an output object span 495. In some embodiments, output object span 495 is a scenario which may have ego machine, agent machine, and occlusion parameters varied as discussed herein to mine many different scenarios. In some embodiments, output object span 495 may be fed back as an input object span 405 to produce a different output object span 495′ after filtering. Varying the number and/or types of filters, and/or their combinations, and/or sequences of operation, enlarges the number of scenarios that may be created.

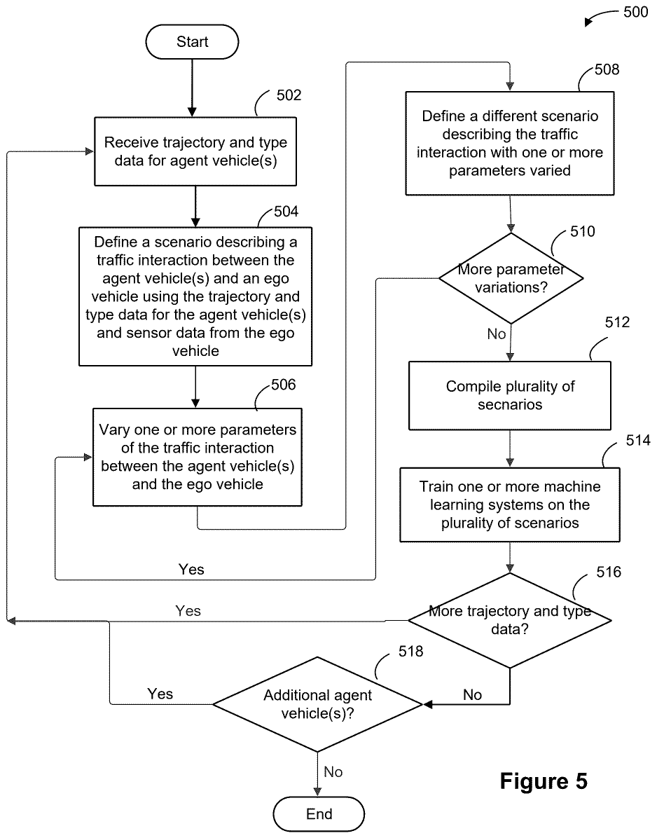

FIG. 4A is not intended to be limiting in terms of how filtering functions are sequenced or combined, or how many filtering functions are used, to produce an output object span 495. Different combinations of filtering functions, and variation of parameters as discussed herein with respect to FIG. 5, may yield a very large number of scenarios which may be used to train one or more machine learning systems on an ego machine to enable the ego machine to navigate properly through many different combinations of agent machine(s) and/or objects and/or occlusions.

In some embodiments, the user may describe a desired scenario, and the system can populate an appropriate mining function template for the user, along the lines of what FIG. 4A depicts. Additionally or alternatively, the user may review a list of existing scenarios, and select one that is identical to or that closely matches the scenario the user is looking for.

The scenarios depicted in FIGS. 3A-3P may be provided as examples to enable a user to create their own scenarios. In some embodiments, a user may indicate the type of scenario that the user wants to mine, and the system may provide a combination and/or sequence of filtering functions to yield the desired output object span. In some embodiments, a user may identify desired filtering functions. A knowledge graph may be generated to link the user's identification to similar or identical scenarios that already have been defined. Additionally or alternatively, a user may search for either particular scenarios or filtering functions. The knowledge graph can link those searches to previously-generated scenarios, and/or to prior combinations of filtering functions to return the scenario(s) that the user desires.

FIG. 4B is a high-level diagram depicting aspects of the disclosed system according to various embodiments. What is shown here is a stack of functions layered one on another. The top layer 412 is where the user devises one or more data mining functions to cover the scenario(s) which the user desires. An application programming interface (API) enables a user to write the data mining function(s). Under that layer is layer 422, which is a software development kit (SDK) that a user can use to create the data mining function(s). Layer 432 is a unified data interface (UDI) which obtains data from the lower layers to provide to the SDK to facilitate the user's development of desired data mining functions. As the name implies, the UDI may provide an interface to the SDK in order to provide data to the SDK, enabling querying of segment labels 442.

In some embodiments, the UDI may query a cloud database to download the appropriate data. The downloading process may be slow, so the UDI may provide a facility to cache queries locally, so that subsequent invocation of those queries can proceed much more quickly.

In some embodiments, a segment label may have three components: start time for a segment; end time for the segment; and label type. The segment label may mark a specific segment of collected data with specific properties. In some embodiments, the label type may signify many different data types of interest—for example, road conditions (wet, dry, icy); weather conditions (sun, rain, snow, sleet, freezing rain, hail, wind); lighting conditions (daytime, nighttime, dawn, dusk, cloudiness); lane counts (number of lanes in either direction of a road); and/or even data such as the name of a city with roads to which the mining scenarios might be applied.

The UDI also may enable querying of agent trajectories and properties 452 to provide data to the SDK. Here, “agent” may mean an item of traffic such as the ego machine, or a car, van, truck, motorcycle, bicycle, and/or pedestrian, etc. “Agent trajectories” can include a number of operating and situational characteristics of an agent, including but not limited to latitude, longitude, course, velocity, acceleration, relative position with respect to the ego machine, and/or timestamp. “Agent properties” can include agent type (including but not limited to the traffic items mentioned above), as well as physical measurements of each agent (e.g. Length, width, height).

The agent trajectories and properties 452 can come from one or more sources. One such source is offline object detection data 462. In some embodiments, this item may signify an offline multi-sensor based 3D object detection and tracking system. The algorithm providing this data may be more precise for object detection and tracking than the algorithm(s) running on the ego machine, which may be LiDAR-based object detection and tracking algorithms.

Another source for agent trajectories and properties 452 may be online objection detection data 472. In some embodiments, this item may signify an online object detection and tracking output system, such as the system running online in the ego machine. Using this system, it is possible to extract agent type and trajectory information from the system logs on board the ego machine.

A third source for agent trajectories and properties may be 4DGT human labeling system 482. This system may be used to put human-provided labels on 3DGT data, which has undergone auto-labeling in an earlier phase. In some embodiments, 3D may denote three physical dimensions, such as planar dimensions (2D) plus depth. In some embodiments, 4D may denote the three physical dimensions, plus time as a fourth dimension.

FIG. 4C shows an exemplary, non-limiting sequence of operation to mine a scenario or set of scenarios. In operation 417, a scenario may be defined. Among the items that can define the scenario are the interaction(s) between the ego machine and agent machine(s); the presence of objects or occlusions; configuration of sensors on the ego machine; weather conditions; and/or lighting conditions. Other potential items are required quantities of data. In some embodiments, there are at least three sources of data: auto-labeled data; human labeled data; and data accumulated while the ego machine is in operation (this data may be referred to as “record while driving” (RWD) data). In some embodiments, the RWD data may be provided as video clips. In some embodiments, auto-labeling may include LiDAR-based auto-labeling. In some embodiments, this auto-labeled data may be 3DGT (ground truth) data. In some embodiments, the human labeled data may include providing human generated labels to auto-labeled data. In some embodiments, the human labeled data may be 4DGT data. In some embodiments, human labeling may involve the provision of bounding boxes around vehicles.

In operation 427, the scenario defined in operation 417 may be mined preliminarily. In some embodiments, this preliminary mining may be performed using 3DGT auto-labeled object trajectories, varying object trajectories to provide additional scenarios that the ego machine may encounter. In operation 437, the data from the mining in operation 417 may be reviewed to identify the appropriate labeling requirement in operation 447. In some embodiments, there may be several types of labels. One type is a bounding box, which may be placed around agent machines and/or non-agent machine occlusions and/or objects, such as pedestrians and bicyclists. For bounding box labels, in operation 487 a scene labeling ticket may be submitted for the data around which the bounding boxes are being placed. The labeled data then is output in operation 497.

Another type of label is the clip label or 3DGT auto-label mentioned herein. Since the data already would have been labeled, the data bearing that label would be output in operation 497. If the label requirement is for 3DGT, in operation 457 a 4DGT labeling ticket would be submitted. In operation 467, a determination is made whether the identity (ID) of each agent machine is necessary. If so, then in operation 477 the mined scenario is mined further using 4DGT data. In some embodiments, the 4DGT data mining may be applied to all of the scenarios that are mined. The 4DGT mined scenario(s) then may be output in operation 497. Finally, if IDs are not needed for each agent machine, then data is output in operation 497.

It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 900 of FIGS. 9A-9E, example computing ecosystem 1000 of FIG. 10, example generative language model system 1100 of FIG. 11, and/or example computing device 1200 of FIG. 12.

Now referring to FIG. 5, each block of method 500, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the system of FIGS. 1-2. However, this method may additionally or alternatively be executed by any one system, or any combination of systems, including, but not limited to, those described herein. Further, the operations in method 500 may be omitted, repeated, and/or performed in any order without departing from the scope of the present disclosure.

FIG. 5 illustrates a flow diagram of a method 500 for generating a plurality of scenarios using target object and feature mining, and training one or more machine learning systems to define additional scenarios, according to various embodiments.

As shown in FIG. 5, method 500 begins with operation 502, in which data-generation pipeline 122 receives trajectory and type data for one or more agent machines. For example, an agent machine may be proceeding on one of the trajectories shown in FIGS. 3A-3P, or may proceed on a different trajectory. Agent machine types can vary among many different types of powered road vehicles, from motorcycles to cars to minivans to pickup trucks to vans to tractor-trailers. In some embodiments, the data-generation pipeline receives type data for one or more targets, such as a pedestrian or a bicyclist. Simulator 216 may use this data to generate simulation data for a scenario. Additionally or alternatively, scenario generator in data-generation pipeline 122 may use the trajectory and type data directly to define the scenario.

In operation 504, scenario definer 218 in data-generation pipeline 122 defines a scenario that describes a traffic interaction between an ego machine and one or more agent machines, using the trajectory and type data for the agent machine(s) and sensor data from the ego machine.

In operation 506, one or more parameters of the traffic interaction between the ego machine and the agent machine(s) are varied. This variation may be used as simulation data to define a scenario, or may be used directly to define a scenario. In operation 508. In operation 510, parameter variation continues until all of the parameter variations are completed, or until a desired number of scenarios has been defined. When parameter variation ends, in operation 512, the defined scenarios are compiled. In operation 514, one or more machine learning systems may be trained on the plurality of scenarios. One purpose of training the one or more machine learning systems is to enable generation of additional scenarios. Another purpose of training the one or more machine learning systems is to enable the ego machine to interact safely with the one or more agent machines, and to handle objects or occlusions safely.

In operation 516, if there is more trajectory and type data, flow returns to operation 502, another plurality of scenarios is compiled, and the one or more machine learning systems trained on that plurality of scenarios.

When execution engine 126 determines that the task should continue being performed, execution engine 126 generates additional states, predictions, and/or actions for subsequent time steps. After a certain number of time steps have passed, execution engine 126 may perform generate state(s) associated with a current time step using a history of preceding states up to a preceding time step, a set of preceding actions associated with the preceding time step, and a set of embedded features associated with the current time step. Also after a certain number of time steps have passed and/or according to another frequency, execution engine 126 may determine whether or not to continue performing the task. Execution engine 126 thus uses the navigation system 242 and machine 260 to perform the task until the task is complete, the task has “timed out,” and/or another condition is met.

FIG. 6 is a more detailed illustration of data-generation pipeline 122 of FIG. 2, according to various embodiments. As discussed herein, data-generation pipeline 122 defines scenarios that can be used to train, evaluate, test, simulate, and/or otherwise operate navigation system 242, other types of machine learning models that can be used by AMRs and/or other machine types to perform tasks, hardware configurations for the machines, and/or other components of the machines.

Within data-generation pipeline 122, simulator 216 generates and/or updates simulation data 232 related to the ego machine, one or more agent machines, and occlusions, and/or one or more environments around the vehicle(s). As shown in FIG. 6, simulation data 232 may include (but is not limited to) maps 612, odometry values 614, images 616, semantic labels 618, and/or bounding shapes 620 (e.g., boxes, squares, rectangles, polygons, etc.).

Maps 612 may include representations of roadways that the vehicle(s) are traversing. For example, a map associated with a given simulation may include a two-dimensional (2D) and/or three-dimensional (3D) grid representing the space around the ego machine. Within the grid, each cell may be associated with a binary value indicating whether or not the corresponding region of space is occupied (e.g., by an object, agent machine, etc.). Each cell may also, or instead, be associated with a probability of the corresponding region of space being occupied. Each cell may also, or instead, be associated with a numeric “cost” that quantifies the difficulty in moving within the corresponding region of space. Maps 612 may also, or instead, include and/or be substituted with point clouds, meshes, and/or other representations of “occupied space” around the ego machine.

Odometry values 614 may include numeric values associated with motion by the ego machines. For example, odometry values 614 for an ego machine within a given simulation may indicate a distance traveled by the ego machine, the position of the ego machine, the heading of the ego machine, the linear and/or angular velocity of the ego machine, the linear and/or angular acceleration of the machine, and/or other information that can be used to derive and/or estimate a position and/or orientation of the ego machine within a corresponding environment-for example, roadways, onramps, offramps, or lanes.

Images 616 may include visual representations of the environment around the ego machine. For example, images 616 may depict the space around the ego machine from the perspectives of cameras and/or other sensor modalities on the ego machine. Images 616 may also, or instead, include birds-eye views of the environments, perspective views of the environments, 360-degree visualizations of the environments, and/or other depictions of the environments that are external to the ego machine and/or individual cameras on the ego machine. Images 616 may include per-pixel color values, depth values, normal values, motion vectors (e.g., between consecutive frames of video), LiDAR intensity values, and/or other types of information that can be used to characterize the environments.

Semantic labels 618 include indications of classes, objects, and/or other properties that assist with understanding of the environments. For example, semantic labels 618 may include semantic segmentations that label individual pixels within images 616, points within point clouds, polygons within meshes, and/or other representations of the environments with the corresponding classes. Semantic labels 618 may also, or instead, identify objects, instances of objects, and/or other entities that are found within individual images, point clouds, meshes, and/or other representations of the environments. In some embodiments, the labels may be produced by one or more of LiDAR-based auto-labeling (for example, 3DGT auto-labeling), human labeling—for example, 4DGT (ground truth) data—or path labels.

Bounding shapes 620 include representations of the locations and/or sizes of objects—for example, agent machines and/or occlusions—within the environments. For example, bounding shapes 620 may include rectangular outlines for the objects within images 616. Bounding shapes 620 may also, or instead, include parallelepiped outlines for the objects within point clouds and/or other 3D representations of the environments. Each bounding shape may be associated with a class label, instance, and/or another indication of a corresponding object.

In one or more embodiments, simulator 216 generates at least a portion of simulation data 232 using physics simulations and/or photorealistic renderings of the machines and/or environments. These physics simulations and/or photorealistic renderings may be performed using a physically-based virtual environment such as NVIDIA Isaac Sim (NVIDIA Isaac SimTM, NVIDIA Isaac GymTM, and/or NVIDIA Drive SimTM, which are registered trademarks of NVIDIA Corporation) that is built on an NVIDIA Omniverse (NVIDIA Omniverse SimTM is a registered trademark of NVIDIA Corporation) platform. The simulation environment may support loading of robot models (e.g., quadruped robots, humanoid robots, differential drive systems, Ackermann drive systems, forklifts, etc.) and/or sensors (e.g., cameras, LiDAR, IMUs, etc.), randomization of environments and/or environmental attributes (e.g., lighting, reflection, color, position, etc.), addition of objects to the environments, and/or the specification of physics, material, and/or collision properties of the objects.

As discussed herein, scenario definer 218 determines one or more scenarios 234 associated with simulation data 232. For example, scenario definer 218 may generate, within a given map outputted by simulator 216, a target location to navigate to or to avoid within a corresponding environment.

In some embodiments, scenario definer 218 defines some or all scenarios 234 based on corresponding scenario parameters 602. For example, scenario parameters 602 may specify that navigation-based goals are to be randomly sampled from the navigable free space within maps 612 generated by simulator 216. Scenario parameters 602 may also, or instead, specify one or more regions within maps 612 from which scenarios 234 are to be preferentially sampled and/or attributes of these regions (e.g., regions with more “detail” and/or objects). Scenario definer 218 may use these scenario parameters 602 to sample scenarios 234 more frequently from the corresponding regions, thereby increasing coverage of tasks associated with the regions in the scenarios.

Planner 220 uses one or more policies 604 to generate commands 236 that instruct machines in simulations performed by simulator 216 to perform actions related to scenarios 234. For example, planner 220 may implement and/or carry out policies 604 that generate commands 236 based on scenarios 234 from scenario definer 218 and odometry values 614 and/or other information from simulator 216. Each policy may include a planning stack, policy, and/or another component that generates commands 236 to operate a machine based on a state of the machine and/or the environment around the machine. These commands 236 may (but are not limited to) a linear and/or angular velocity, trajectory, path, and/or another indication of motion that advances a machine toward a certain scenario 234 from scenario definer 218 while avoiding objects in a corresponding simulated environment.

Each set of commands 236 outputted by planner 220 may be sent to simulator 216, which updates simulation data 232 based on the corresponding action. For example, planner 220 may generate a given set of commands 236 based on simulation data 232 associated with a given time step in a simulation. These commands 236 may be transmitted to simulator 216, which generates updated simulation data 232 for the next time step. This simulation data 232 for the next time step may reflect changes to the machine and/or environment after the machine performs actions corresponding to commands 236. Simulator 216 may then send some or all of the updated simulation data 232 to planner 220 to allow planner 220 to generate a new set of commands 236 based on the updated simulation data 232 and the corresponding scenario 234 from scenario definer 218. This process may repeat until scenario 234 is reached, a certain number of time steps has been executed within the simulation, and/or another condition indicating the end of the simulation is met.

Data logger 222 aggregates simulation data 232, scenarios 234, commands 236, and/or other data generated by simulator 216, scenario definer 218, and planner 220 into records 238 of events associated with the corresponding time steps. For example, simulator 216, scenario definer 218, and/or planner 220 may include and/or be associated with nodes that implement publishers in a publish-subscribe messaging system such as Robot Operating System (ROS). Each publisher may publish messages and/or events associated with a corresponding component of data-generation pipeline 122 (e.g., simulator 216, scenario definer 218, planner 220, etc.) to one or more topics. Data logger 222 may include and/or be associated with nodes that implement subscribers to these topic(s) within the publish-subscribe messaging system. Each subscriber may receive messages from one or more corresponding topics. Data logger 222 may log data from the received messages by pre-processing 606 the data and storing the pre-processed data in records 238.

In one or more embodiments, pre-processing 606 includes determining an order in which data and/or events occur within a given simulation; generating records 238 that span a certain time interval and/or at a certain frequency; downsampling some or all of the logged data; and/or other data-processing operations associated with data from simulator 216, scenario definer 218, and/or planner 220. For example, data logger 222 may synchronize data that is published at different frequencies by simulator 216, scenario definer 218, and planner 220 by associating the published data with individual “frames” of time, time intervals, time steps, and/or other discrete measures of time within each simulation. Data logger 222 may also store the data associated with each discrete measure of time in one or more records corresponding to that measure of time. In another example, data logger 222 may downsample images 616, semantic labels 618, bounding shapes 620, and/or other high-resolution data from simulator 216 prior to storing the data in records 238. In a third example, data logger 222 may store records 238 associated with a given scenario (e.g., a combination of a particular environment, machine, scenario, policy, simulation, etc.) with a path and/or directory corresponding to the scenario. Data logger 222 may also, or instead, associate individual records 238 with unique identifiers and/or names for the corresponding scenarios.

In some embodiments, data logger 222 generates visualizations and/or charts of data in records 238 as records 238 are created. For example, data logger 222 may output, in a graphical user interface, images 616, semantic labels 618, bounding shapes 620, maps 612, odometry values 614, and/or other visual representations of simulation data 232. Data logger 222 may also, or instead, output “map pins,” routes, and/or other representations of scenarios 234 and/or guidance related to scenarios 234 within the corresponding maps 612, birds-eye views of environments in simulations, and/or other visual depictions of the environments. Data logger 222 may also, or instead, output paths, trajectories, and/or other visual representations of commands 236 and/or actions performed based on commands 236 as overlays on images 616, maps, and/or other representations of the environments. This outputted information may allow users to visually review the logged data, determine whether or not the logged data accurately reflects the corresponding scenarios, and/or determine whether or not the logged data can be used with various use cases and/or applications.

Post-processor 224 performs post-processing 608 that adapts records 238 and/or other data generated by the other components of data-generation pipeline 122 to various machine learning models and/or use cases. For example, post-processor 224 may resample, compress, smooth, format, and/or otherwise convert data in a given set of records 238 into a form (e.g., file format, schema, etc.) that can be used to train, test, and/or evaluate a machine learning model, hardware configuration, digital twin, and/or other components of a physical and/or virtualized machine. Post-processor 224 may also, or instead, store each set of records 238 that has been post-processed for a given purpose and/or in a certain way in one or more corresponding datasets 240.

In some embodiments, post-processor 224 generates and stores metadata that is associated with logged data in datasets 240. For example, post-processor 224 may store, in associated with a dataset for a given scenario, a number of instances of object types (e.g., forklifts, shelves, people, etc.) in the scenario, time intervals between consecutive frames represented by records 238 in the dataset, a distance covered by a machine in the scenario, a distribution of actions performed by the machine, and/or other metrics and/or statistics associated with the simulated operation of the machine in the scenario. In another example, post-processor 224 may specify, in metadata for a given dataset, scenario parameters 602, policies 604, pre-processing 606 and/or post-processing 608 techniques, and/or other types of configuration parameters 622 used to generate the dataset.

In some embodiments, some or all components of data-generation pipeline 122 are configured and/or customized via configuration parameters 622 provided by a control module 610. For example, configuration parameters 622 may specify a machine type and/or model, an initial pose for the machine, a scene, one or more objects within the scene, properties of the objects, and/or other information that can be used by simulator 216 to conduct simulations. Configuration parameters 622 may also, or instead, include scenario parameters 602 that are used to control the generation of scenarios 234 by scenario definer 218. These scenario parameters 602 may specify the types of scenarios 234 to be generated (e.g., location-based goals, tasks, etc.), sampling techniques used to define scenarios 234, regions within environments from which scenarios 234 are to be preferentially sampled, attributes of regions within environments from which scenarios 234 are to be preferentially sampled, weights and/or other measures of importance associated with sampling scenarios 234 from various regions within the environments, times at which one or more new scenarios 234 are to be sampled (e.g., after one or more existing scenarios 234 have been reached), and/or other parameters that can be used to control and/or modify the generation of scenarios 234 by scenario definer 218. Configuration parameters 622 may also, or instead, include specific policies 604 to be used by planner 220 in generating commands 236, behavioral attributes (e.g., a level of aggressiveness and/or conservatism in executing a scenario; types of commands 236 to be generated; minimum, maximum, and/or valid values associated with commands 236; etc.) associated with those policies 604, text-and/or code-based instructions for policies 604, platforms and/or frameworks used to implement policies 604, and/or other information that can be used to implement policies 604 and/or generate commands 236. Configuration parameters 622 may also, or instead, include parameters related to publishing and/or subscribing to topics by components of data-generation pipeline 122. Configuration parameters 622 may also, or instead, include identifiers, paths, logging frequencies, downsampling parameters, resampling parameters, file formats, schemas, visualization types, and/or other information that can be used to perform pre-processing 606 and/or post-processing 608 associated with data in records 238 and/or datasets 240.

Configuration parameters 622 may be defined and/or updated using various techniques. For example, configuration parameters 622 may be provided by one or more users via one or more configuration files, application programming interfaces (APIs), user interfaces, and/or other mechanisms. Some or all configuration parameters 622 may also, or instead, be randomly generated (e.g., by sampling from distributions, ranges, and/or sets of valid configuration parameters 622). Some or all configuration parameters 622 may also, or instead, be generated and/or updated using machine learning, optimization, and/or search techniques (e.g., to increase coverage of environments and/or scenarios by datasets 240 and/or define scenarios related to specific environments). Control module 610 may transmit configuration parameters 622 to simulator 216, scenario definer 218, planner 220, data logger 222, and/or post-processor 224. Control module 610 may also, or instead, configure the operation of simulator 216, scenario definer 218, planner 220, data logger 222, and/or post-processor 224 using the corresponding configuration parameters 622.

In some embodiments, configuration parameters 622 include a unique name and/or identifier for a given scenario (e.g., a combination of a particular environment, ego machine, agent machine(s), occlusions, etc.) under which data is to be generated and collected. Configuration parameters 622 may also be used to customize and/or randomize the environment and/or type of machine to be simulated, the scenario, the type of data to log, the frequency with which the data is logged, and/or the way in which the logged data is converted into a format that is suitable for training and/or evaluating a machine learning model and/or another component of the machine.

In some embodiments, different sets of configuration parameters 622 are used to launch different instances of data-generation pipeline 122 to generate data that depicts different scenarios related to navigation and/or other types of tasks performed by machines in environments. For example, multiple instances of data-generation pipeline 122 may be launched in parallel on multiple nodes of a cloud computing system using an NVIDIA One-system-to-many-others (OSMO) workflow. Each instance may be used to generate and/or collect simulation data 232, scenarios 234, commands 236, records 238, and/or datasets 240 associated with a given scenario and/or set of scenarios. The number of instances of data-generation pipeline 122 and/or the number of nodes on which a given instance of data-generation pipeline 122 is deployed may be scaled to accommodate requirements and/or preferences associated with the number of scenarios to generate; applications and/or use cases associated with the scenarios; coverage of environments, machines, policies 604, scenarios 234, and/or other factors. Additional OSMO workflows may also be used to launch pipelines that are used to train, test, and/or evaluate machine learning models, policies, hardware configurations, software stacks, twins, and/or other components or representations of machines using the generated simulation data 232, scenarios 234, commands 236, records 238, and/or datasets 240.

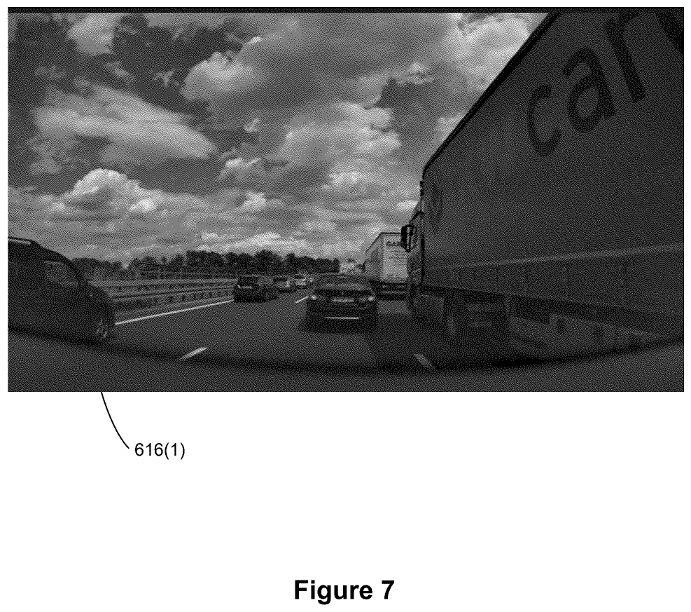

FIG. 7 illustrates example data generated by data-generation pipeline 122 of FIG. 2 to create a scenario, according to various embodiments. As shown in FIG. 7, the data includes an image 616(1) that depicts a roadway environment around an ego machine at a given time step within a simulation. Image 616(1) includes a perspective view of the environment from a camera that is at the front of the ego machine. Simulator 216 may render this image 616(1) based on a 3D scene representing the environment, odometry values 614 associated with the machine at the time step, and/or other simulation data 232.

A scenario also may include a set of commands 236 associated with the same time step. These commands 236 (FIG. 2) may include trajectory, linear velocity, and/or angular velocity. These commands 236 may be used to update the state of the machine and/or the environment within the simulation. The updated state(s) may then be used to generate new images 616, other simulation data 232, and/or commands 236 for the next time step in the simulation.

Ordinarily skilled artisans will appreciate that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

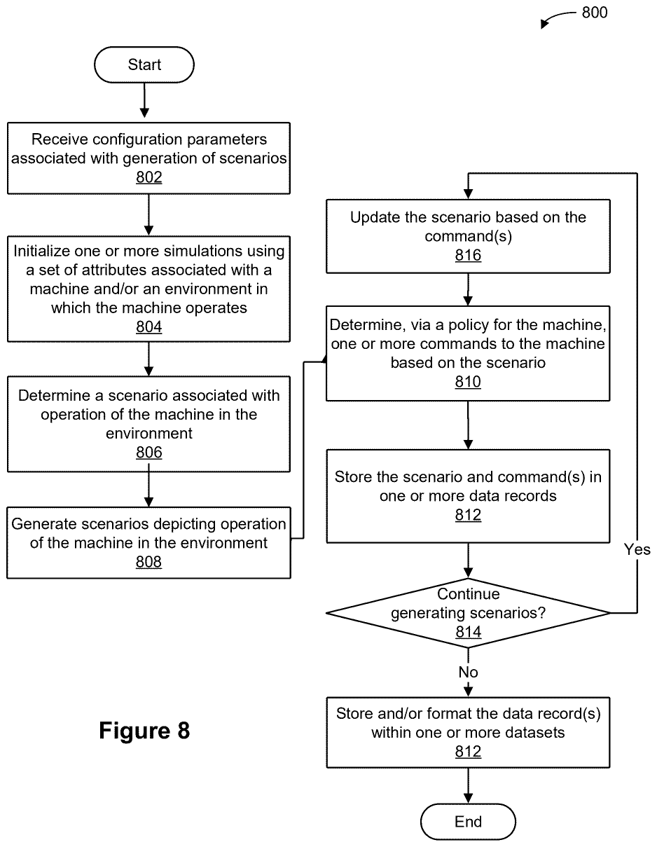

Now referring to FIG. 8, each block of method 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 800 is described, by way of example, with respect to the systems of FIGS. 1 and 6. However, these methods may additionally or alternatively be executed by any one system, or any combination of systems, including, but not limited to, those described herein.

FIG. 8 illustrates a flow diagram of a method 800 for generating scenarios associated with a machine in an environment, according to various embodiments. As shown in FIG. 8, method 800 begins with operation 802, in which data-generation pipeline 122 receives configuration parameters associated with generation of the scenarios. For example, data-generation pipeline 122 may receive the configuration parameters via one or more configuration files, API calls, and/or user interfaces. The configuration parameters may be used to configure and/or customize the generation of the scenarios. For example, the configuration parameters include a unique name and/or identifier for a given combination of conditions (e.g., a combination of a particular environment, machine, scenario, etc.) under which data is to be generated and collected. The parameters may also be used to customize the environment and/or type of machine to be simulated, the scenario, the type of data to log, the frequency with which the data is logged, and/or the way in which the logged data is converted into a format that is suitable for training and/or evaluating a machine learning model and/or another component of the machine. In the flow chart of FIG. 5, parameters and other data get varied for a particular scenario to define other scenarios with which to train one or more machine learning models.

In operation 804, data-generation pipeline 122 initializes one or more simulations using a set of attributes associated with the machine and/or the environment in which the machine operates. For example, data-generation pipeline 122 may use the configuration parameters to determine the machine type, machine model, and/or position of the machine in the environment. Data-generation pipeline 122 may also, or instead, obtain, generate, and/or randomize data-for example, trajectory and type data, and parameters of traffic interaction between machines (e.g. an ego machine and agent machine(s)), and/or a 3D scene corresponding to the environment and/or a map of the 3D scene. Data-generation pipeline 122 may also, or instead, add one or more objects to the 3D scene and/or set physics, material, and/or collision properties of the object(s).

In operation 806, data-generation pipeline 122 determines a scenario associated with operation of the machine in the environment. For example, data-generation pipeline 122 may define a navigation-based scenario by sampling a location to which the machine is to navigate within the environment from unoccupied space within the environment. This sampling may be performed preferentially for certain regions within the environment that are specified in the configuration parameters and/or for certain regions with attributes that are specified in the configuration parameters.

In operation 808, data-generation pipeline 122 generates, via the simulation(s), simulation data depicting the operation of the machine in the environment. For example, data-generation pipeline 122 may render one or more images of the environment from the perspective of one or more cameras on the machine, one or more locations that are external to the machine, and/or other viewpoints. Data-generation pipeline 122 may also, or instead, generate point clouds, IMU measurements, and/or other sensor measurements associated with sensors on the machine.

In operation 810, data-generation pipeline 122 determines, via a policy for the machine, one or more commands to the machine based on the simulation data and/or scenario. For example, data-generation pipeline 122 may input the simulation data and/or scenario into a planning stack, neural network, and/or another component implementing the policy. Given the inputted data, the component may generate commands that specify linear and/or angular velocities for the machine. The component may also, or instead, generate one or more distributions of commands from which the command(s) are sampled.

In operation 812, data-generation pipeline 122 stores the simulation data and command(s) in one or more data records. For example, data-generation pipeline 122 may associate the simulation data generated in operation 808 and the commands generated in operation 810 with the same time step and/or “frame” within the simulation(s). Data-generation pipeline 122 may also log the simulation data and command(s) in one or more data records associated with the time step and/or frame.

In operation 814, data-generation pipeline 122 determines whether to continue generating scenarios. For example, data-generation pipeline 122 may determine that generation of scenarios is to continue until there are enough scenarios to train the one or more machine learning models which will operate the machine, the simulation(s) have run for a certain number of time steps, and/or another condition is met. If data-generation pipeline 122 determines that generation of scenarios is to continue, data-generation pipeline 122 performs operation 816, in which data-generation pipeline updates the simulation data based on the command(s). For example, data-generation pipeline 122 may update the position, heading, velocity, and/or another state of the machine to reflect execution of the command(s) by the machine. Data-generation pipeline 122 may also, or instead, generate new images and/or sensor data that reflect the updated machine state.

Data-generation pipeline 122 then repeats operation 810 to generate new commands based on the updated simulation data. Data-generation pipeline 122 similarly repeats operation 812 to store the updated simulation data and command(s) in one or more additional data records. For example, data-generation pipeline 122 may store the updated simulation data and command(s) in association with a new (e.g., incremented) time step and/or frame. After a given set of simulation data and command(s) has been stored in one or more data records, data-generation pipeline 122 repeats operation 814 to determine whether or not to continue generating scenarios.

After data-generation pipeline 122 determines in operation 814 that generation of scenarios is to be discontinued, data-generation pipeline 122 performs operation 816, in which data-generation pipeline 122 stores and/or formats the data record(s) within one or more datasets. For example, data-generation pipeline 122 may generate a different dataset for each use case and/or application associated with the scenarios. Within a given dataset, data-generation pipeline 122 may resample, format, and/or otherwise post-process the corresponding data records to adapt the data records to the corresponding use case and/or application. Data-generation pipeline 122 may then provide the dataset for use in training, testing, and/or evaluating machine learning models, hardware configurations, policies, digital twins, and/or other components and/or representations of machines in various environments.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 9A is an example of sensor locations having corresponding fields of view or sensory fields for an autonomous or semi-autonomous vehicle 900A, an autonomous mobile robot (AMR) 900B, and a humanoid robot 900C, in accordance with some embodiments of the present disclosure. Although three types of machines 900 are illustrated, this is not intended to be limiting, and the machine(s) 900 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 900A, AMR 900C, humanoid robot 900C, and/or other machine types may be referred to herein collectively as machine 900, in some instances.

With respect to vehicles 900A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 900 may be capable of functionality in accordance with one or more of Level 3-Level 5 of the autonomous driving levels. The machine 900 may be capable of functionality in accordance with one or more of Level 1-Level 5 of the autonomous driving levels. For example, the machine 900 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 900 or other machine, such as being fully autonomous, being highly autonomous, being conditionally autonomous, being partially autonomous, providing assistive autonomy, being semi-autonomous, being primarily autonomous, or other designation.

With respect to FIG. 9A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 968D, a 180 degree field of view of a wide view camera 968B, a 360 degree sensory field of a LiDAR sensor 964, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 900a, AMR 900b, and/or humanoid robot 900c, etc. For example, with respect to the vehicle 900a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 900b and/or humanoid robot 900c, the shape, size, purpose, implementation, model, etc. may dictate the number and types of sensors used.

As illustrated in FIG. 9A, the autonomous or semi-autonomous vehicle 900A, the AMR 900B, and the humanoid robot 900C may include different sensor types, number, and locations. For a non-limiting example, the vehicle 900A may include twelve cameras 968, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 968 may use, in embodiments, a gigabit multimedia serial link (GMSL) interface—such as GMSL2-as input/output (I/O).

In some embodiments, although not illustrated in FIG. 9A, the vehicle 900A may include an in-cabin occupant and/or driver monitoring system, that may include various different sensors. For example, the in-cabin sensors may include various cameras 968, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 968, the internal camera(s) 968 may, in embodiments, use a GMSL (such as GMSL2) interface for I/O.

As another non-limiting example, the vehicle 900A may further include nine RADAR sensors 960. For example, the vehicle 900A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 960 may use, in embodiments, an Ethernet interface as I/O.

The vehicle(s) 900A may further include, as a non-limiting example, twelve ultrasonic sensors 962. As illustrated in FIG. 9A, the ultrasonic sensors may be positioned along the front and rear bumpers of the vehicle 900A, and along the side of the vehicle 900A, and may be used to detect objects (static and dynamic) in close proximity to the vehicle 900A. In some embodiments, the ultrasonic sensor(s) 962 may use a DS13 interface as I/O.

The vehicle(s) 900A may further include, as a non-limiting example, a LiDAR sensor 964, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 964 may include a 360 degree horizontal FOV or sensory field (such as in a spinning LiDAR sensor) and a 90 degree vertical FOV or sensory field. In some embodiment, the LiDAR sensor(s) 964 may use an Ethernet interface as I/O.

The autonomous mobile robot (AMR) 900B may include, as a non-limiting example, three LiDAR sensors 964. For example, the top-most illustrated LiDAR sensor 964 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 900B may further include, as a non-limiting embodiment, eight cameras 968, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree +−3 degree FOV).

The AMR 900B may further include a charging port, charging port contacts, a status indicator light, one or more (e.g., four) RGB LEDs, one or more IMU sensors 966, a magnetometer, and a barometer. The AMR 900B is capable of high-precision time synchronization between sensors using hardware time stamping, and PTP over Ethernet with less than 10 microseconds for sensor acquisition time. The AMR 900B provides simultaneous camera capture across all cameras 968 within 100 microseconds from a single hardware trigger, in embodiments, and can write to disk at 4GB/second for sensor capture to bag writing (e.g., writing to ROSbags for the robot operation system (ROS)). As such, the AMR 900B is capable of running the ROS (such as NVIDIA's Isaac ROS), can be teleoperated (as described herein), can map an environment, and can navigate within an environment using visual cameras 968, LiDAR sensors 964, and/or other sensor types or modalities.

The humanoid robot 900C may include, as a non-limiting example, one LiDAR sensor 964. For example, the LiDAR sensor 964 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 900C may further include, as a non-limiting embodiment, four cameras 968, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 900C may further include, as a non-limiting embodiment, four ultrasonic sensors 962, such as a left arm ultrasonic sensor, a right arm ultrasonic sensor, a left leg ultrasonic sensor, and right leg ultrasonic sensor.

The humanoid robot 900C may further include any number of actuators—such as to allow control and maneuverability of joints. For example, the humanoid robot 900C may include actuators that allow for various degrees of freedom (DoF) depending on the design. In a non-limiting embodiment, the humanoid robot 900C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 900C may include position and orientation sensors, such as encoders, gyroscopes, and the like, to determine the position of the robot 900C in space, allowing for location determination and movement tracking. The humanoid robot 900C may include force and pressure sensors, in embodiments, to detect environment interactions, allowing the robot 900C to grasp objects with the right force and to avoid obstacles along the way. The perception sensors (e.g., cameras, LiDARs, RADARs, ultrasonic, SONAR, etc.) may be used along with tactile sensors to allow the robot 900C to perceive objects, shapes, and textures, and to understand when touch is initiated and stopped (along with force sensors that regulate the force used during touch). As a non-limiting example, the humanoid robot 900C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 900C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 900C may use onboard sensors, microphones, and speakers to understanding speech, audio and visual cues, etc., while also being able to communicate back to the environment.

With reference to cameras 968 of the machine(s) 900, the camera types for the cameras 968 may include, but are not limited to, digital cameras that may be adapted for use with the components and/or systems of the machine 900. For a vehicle 900a implementation, the camera(s) 968 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 968B that may be used to perceive objects coming into view from the periphery (e.g., pedestrians, warehouse vehicles, other robots, crossing traffic, or bicycles). In addition, any number of long-range camera(s) 968E (e.g., a long-view stereo camera pair) may be used for depth-based object detection, especially for objects for which a neural network has not yet been trained. The long-range camera(s) 968E may also be used for object detection and classification, as well as basic object tracking.

Any number of stereo cameras 968A may also be included in a front-facing and/or other (e.g., rear-facing) configuration. In at least one embodiment, one or more of stereo camera(s) 968A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 900 environment, including a distance estimate for points in the image (e.g., a disparity or depth image). An alternative stereo camera(s) 968A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 900 (e.g., side-view cameras) may be used, for example, for surround view, providing information used to create and update the occupancy grid, as well as to generate side impact collision warnings and/or to indicate to an AMR 900B or humanoid robot 900C, for example, that there are objects, features, and/or persons present to the side. For example, surround camera(s) 968D may be positioned on the machine 900. The surround camera(s) 968D may include wide-view camera(s) 968B, fisheye camera(s), 360 degree camera(s), and/or the like. For example, four fisheye cameras may be positioned on the machine's 900 front, rear, and sides. In an alternative arrangement, the machine 900 may use three surround camera(s) 968D (e.g., left, right, and rear), and may leverage one or more other camera(s) (e.g., a forward-facing camera) as a fourth surround view camera.

Cameras 968 with a field of view that include portions of the environment to the rear of the machine 900 (e.g., rear-view cameras) may be used for gaining an understanding of objects, features, persons, and/or other information to the rear of the machine 900, such as for park assistance, surround view, rear collision warnings, planning, control, and navigation determinations, and/or creating and updating an occupancy grid, BEV image representing the environment, height map, etc. A wide variety of cameras 968 may be used including, but not limited to, cameras 968 that are also suitable as a front-facing camera(s) (e.g., long-range and/or mid-range camera(s) 968E, stereo camera(s) 968A), infrared camera(s) 968C, etc.), rear-facing camera(s), side-facing camera(s), downward facing camera(s), upward facing camera(s), and/or the like, as described herein.

Similarly, for LiDAR sensors 964, RADAR sensors 960, ultrasonic sensors 962, and/or other sensor modalities or types, the location and placement of the sensors, and their corresponding fields of view or sensory fields may be determined based on the use case, implementation, or design of the particular machine 900.

For example, the machine(s) 900 include RADAR sensor(s) 960 that may be used by the machine 900 for long-range object detection, even in darkness and/or severe weather conditions. RADAR functional safety levels may be ASIL B, in embodiments. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 900 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 960 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 900 (e.g., vehicle, robot, etc.). As such, short-range RADAR systems may be used in an ADAS system for blind spot detection and/or lane change assist.

The machine 900 may further include ultrasonic sensor(s) 962. The ultrasonic sensor(s) 962, which may be positioned at the front, back, and/or the sides of the machine 900, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 900. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B, as an example.

The machine 900 may include LiDAR sensor(s) 964. The LiDAR sensor(s) 964 may be used for object and feature detection, pedestrian and other robot detection, emergency braking, collision avoidance, simultaneous localization and mapping (SLAM), free-space detection, and/or other functions. The LiDAR sensor(s) 964 may be functional safety level ASIL B, in embodiments. In some examples, the machine 900 may include multiple LiDAR sensors 964 (e.g., two, four, six, etc.) that may use Ethernet (e.g., to provide data to a Gigabit Ethernet switch).

In some examples, the LiDAR sensor(s) 964 may be capable of providing a list of objects and their distances for a 360-degree field of view. Commercially available LiDAR sensor(s) 964 may have an advertised range of approximately 900 m, with an accuracy of 2 cm-3 cm, and with support for a 900 Mbps Ethernet connection, for example. In some examples, one or more non-protruding LiDAR sensors 964 may be used. In such examples, the LiDAR sensor(s) 964 may be implemented as a small device that may be embedded into the front, rear, sides, top, and/or corners of the machine 900. The LiDAR sensor(s) 964, in such examples, may provide up to a 120-degree horizontal and 35-degree vertical field-of-view, with a 200 m range even for low-reflectivity objects. Front-mounted LiDAR sensor(s) 964 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 900. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 964 may be less susceptible to motion blur, vibration, and/or shock.

FIG. 9B is an illustration of sensor and component locations of an example autonomous or semi-autonomous vehicle 900A (alternatively referred to herein as “vehicle 900,” “ego-vehicle 900,” “ego-machine 900,” or “machine 900,”), in accordance with some embodiments of the present disclosure. Although the vehicle 900A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 9C is a block diagram of an example system architecture for a machine 900, such as autonomous or semi-autonomous vehicle 900A, autonomous mobile robot (AMR) 900B, humanoid robot 900C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 900 of FIGS. 9A-9E, example computing ecosystem 1000 of FIG. 10, example generative language model system 1100 of FIG. 11, and/or example computing device 1200 of FIG. 12.

Each of the components, features, and systems of the machine 900 in FIG. 9C are illustrated as being connected via bus 902 (alternatively referred to as a “machine communications network 902,” or just “communications network 902”). The bus 902 may include a Controller Area Network (CAN) data interface (alternatively referred to herein as a “CAN bus”). A CAN may be a network inside the machine 900 used to aid in control of various features and functionality of the machine 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 902 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the machine 900, and two or more busses 902 may communicate with the same components. In some examples, each SoC 904, each controller 936, and/or each computer or compute engine within the machine 900 may have access to the same input data (e.g., inputs from sensors of the machine 900), and may be connected to a common bus, such as a CAN bus.

The machine 900 may include components such as a chassis, a vehicle body, wheels (e.g., 2, 4, 6, 8, 18, etc.), tires, axles, batteries, side-view mirrors, and/or other components of a vehicle or machine. The machine 900 may include a propulsion system 950, such as an internal combustion engine, hybrid electric power plant, an all-electric engine, a hydrogen-fueled engine, and/or another propulsion system type. The propulsion system 950 may be connected to a drive train of the machine 900, which may include a transmission, to enable the propulsion of the machine 900. The propulsion system 950 may be controlled in response to receiving signals from the throttle/accelerator 952.

A steering system 954, which may include a steering wheel and/or other steering device (e.g., remote steering and/or local steering), may be used to steer the machine 900 (e.g., along a desired path or route) when the propulsion system 950 is operating (e.g., when the vehicle is in motion). The steering system 954 may receive signals from a steering actuator 956. In some embodiments, a steering wheel or other steering mechanism may not be included, such as for a machine 900 capable of full automation (e.g., Level 5) functionality.

The brake sensor system 946 may be used to operate the vehicle brakes in response to receiving signals from the brake actuators 948 and/or brake sensors.

The machine 900 may include one or more controller(s) 936, such as those described herein with respect to FIG. 9A. The controller(s) 936 may be used for a variety of functions, and may be coupled to any of the various other components and systems of the machine 900. For example, the controllers 936 may be used for control of the machine 900, artificial intelligence executing on the machine 900, infotainment for the machine 900, and/or the like. For example, one controller 936 may be used for some or all of the functionality, or different controllers 936 may be used for different functionalities-e.g., to ensure availability and a safety separation between various controllers for different tasks. For example, the controller(s) 936 may use plans computed by the system—e.g., paths or trajectories for vehicles 900A or AMRs 900B, or movements, components trajectories, movement locations or displacements, etc. for joints or components (e.g., of manipulators, end effectors, limbs, hands, fingers, legs, feet, etc.), of a humanoid robot 900C—to control the machine(s) 900 in the environment. In some instances, the controller(s) 936 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 900C, for example, the controller(s) 936 may act as the brain, responsible for analyzing sensor data, making decisions, and sending commands to the actuators. The controller(s) 936 may include a low-level controller that handles basic motor control, ensuring accurate and precise movements of individual joints and actuators. The controller(s) 936 may include a high-level controller to coordinate multiple actuators and sensors, planning complex motions and adapting to changing environments.

The controller(s) 936 may include an artificial intelligence controller, in embodiments, that may use AI algorithms (e.g., DNNs, MLMs, etc.) to learn, make decisions, and autonomously perform tasks for the machine 900. In some embodiments, the controller(s) 936 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 936 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 936, which may include one or more systems on chip (SoCs) 904 (FIGS. 9C and 9D), CPUs, GPU(s), accelerator(s), etc., may provide signals (e.g., representative of commands or messages) to one or more components and/or systems of the machine 900. Although the controller(s) 936 is listed separately from the SoC(s) 904, this is not intended to be limiting, and in some embodiments one or more components of the SoC(s) 904 may perform the operations of the controller(s) 936. For example, the controller(s) may send signals to operate the machine brakes via one or more brake actuators 948, to operate the steering system 954 via one or more steering actuators 956, to operate the propulsion system 950 via one or more throttle/accelerators 952, etc. The controller(s) 936 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 900. The controller(s) 936 may include a first controller 936 for autonomous control and navigation functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 936 may handle two or more of the above functionalities, two or more controllers 936 may handle a single functionality, and/or any combination thereof.

The controller(s) 936 may provide the signals for controlling one or more components and/or systems of the machine 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LiDAR sensor(s) 964, inertial measurement unit (IMU) sensor(s) 966 (e.g., accelerometer(s), gyroscope(s), magnetic compass(es), magnetometer(s), etc.), microphone(s) 996, camera(s) 968 (e.g., stereo camera(s) 968A, wide-view camera(s) 968B (e.g., fisheye cameras), infrared camera(s) 968C, surround camera(s) 968D (e.g., 360 degree cameras), long-range and/or mid-range camera(s) 968E, and/or other camera types), speed sensor(s) 944 (e.g., for measuring the speed of the machine 900), vibration sensor(s) 942, steering sensor(s) 940, brake sensor(s) (e.g., as part of the brake sensor system 946), actuators, and/or other sensor types.

One or more of the controller(s) 936 may receive inputs (e.g., represented by input data) from an instrument cluster 932 of the machine 900 and provide outputs (e.g., represented by output data, display data, etc.) via a human-machine interface (HMI) display 934 (e.g., screen, heads-up display, mirror display, facial display, robotic display, etc.), an audible annunciator, a loudspeaker, a speaker, and/or via other components of the machine 900. The outputs may include information such as machine velocity, speed, time, map data corresponding to a map(s) 922 of FIG. 9C (e.g., from a navigation map, a Standard Definition (SD) map, a High Definition (“HD”) map, etc.), location data (e.g., the machine's 900 location, such as on a map 922), direction, location of other vehicles (e.g., an occupancy map, height map, bird's eye view (BEV) image, grid, etc.), information about objects and status of objects as perceived by the system, system status information, etc. For example, the HMI display(s) 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 900 may include one or more systems on a chip (SoCs) 904 (described in more detail in FIG. 9D). The SoC(s) 904 may include CPU(s) 906, GPU(s) 908, processor(s) 910, cache(s) 912, accelerator(s) 914, data store(s) 916, and/or other components and features. The SoC(s) 904 may be used to process and provide data for various operations, such as navigation, planning, reasoning, inference, perception, control, and/or actuation operations of the machine 900 in a variety of platforms and systems. For example, the SoC(s) 904 may process live perception data (e.g., from camera, LiDAR, RADAR, ultrasonic, etc.) in addition to map data corresponding to one or more maps 922 (e.g., HD map, SD map, navigational map, occupancy map, etc.) in order to make or aid in performing various operations of the machine 900. Where a map and/or AI is used, map and/or AI (e.g., model parameter updates, fine-tuning, etc.) refreshes and/or updates via a network interface 924 from one or more servers (e.g., server(s) 978 of FIG. 9E)—such as one or more servers of a cloud-based data center.

Although an SoC(s) 904 is illustrated throughout FIGS. 9A-9E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 900, use of the machine 900, model of the machine 900, and required capabilities of the machine 900, one or more SoCs 904 and/or alternative architectures and/or components may be used to satisfy the particular implementation.

The machine 900 may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The machine 900 may include a GPU(s) 920 (e.g., discrete GPU(s), or dGPU(s)), that may be coupled to the SoC(s) 904 via a high-speed interconnect (e.g., NVIDIA's NVLink). The GPU(s) 920 may provide additional artificial intelligence functionality, such as by executing redundant and/or different neural networks, and may be used to train and/or update neural networks based on input (e.g., sensor data) from sensors of the machine 900.

The machine 900 may further include the network interface 924 which may include one or more wireless antennas 926 and/or modems (e.g., one or more wireless antennas for different communication protocols, such as a cellular antenna, a Bluetooth antenna, etc.). The network interface 924 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 900 information about vehicles in proximity to the machine 900 (e.g., vehicles in front of, on the side of, and/or behind the machine 900). This functionality may be part of a cooperative adaptive cruise control functionality of the machine 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The machine 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The machine 900 may further include IMU sensor(s) 966. The IMU sensor(s) 966 may be located at a center of the rear axle of the machine 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the machine 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include one or more microphone 996 placed in and/or around the machine 900. The microphone(s) 996 may be used for emergency vehicle detection and identification, among other things.

The machine 900 may further include vibration sensor(s) 942. The vibration sensor(s) 942 may measure vibrations of components of the machine, such as the arms or legs of a humanoid robot 900C, or the axle(s) of a vehicle 900A or AMR 900B. For example, changes in vibrations may indicate a change in road, walking, or traversable surfaces. In another example, when two or more vibration sensors 942 are used, the differences between the vibrations may be used to determine friction or slippage of the surface (e.g., when the difference in vibration is between a power-driven axle and a freely rotating axle).

The machine 900 may include an ADAS system 938—such as when the machine 900 is a vehicle 900A. The ADAS system 938 may include a dedicated SoC(s), in some examples. The ADAS system 938 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 900 may further include the infotainment SoC 930 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the machine 900. In some examples, the infotainment SoC 930 may be coupled to a supervisory MCU such that the GPU of the infotainment system may perform some self-driving functions in the event that the primary controller(s) 936 (e.g., the primary and/or backup computers of the machine 900) fail. In such an example, the infotainment SoC 930 may put the machine 900 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 900—whether a vehicle 900A, AMR 900B, humanoid robot 900C, and/or other type of machine—may include a locally stored language model(s) and/or communicate to a remotely hosted language model (e.g., via one or more APIs) to provide more detailed and in-depth communication features to the users of the machine(s) 900.

In some examples, an infotainment SoC 930, the SoC(s) 904, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 900.

The machine 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a block diagram of an example architecture of a computing system (a subset of the system described with respect to FIG. 9C), in accordance with at least some embodiments of the present disclosure. Although illustrated as an SoC(s) 904, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 904 may be an end-to-end platform with a flexible architecture that spans automation levels 2-5, or the SoC(s) 904 may be specifically designed for a specific automation level (e.g., a first SoC 904 for level 2 to level 2++, a second SoC 904 for level 3, a third SoC 904 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 2-5 autonomous vehicles as well as for safe planning, navigation, and control of AMRs 900B, humanoid robots 900C, and/or other robot or machine types.

In some embodiments, such as where the SoC(s) 904 include a GPU 908 with 2000 or more cores (e.g., 2048 cores), 60 or more tensor cores (e.g., 64 tensor cores), and a GPU max frequency of over 1 GHz (e.g., 1.3 GHz), a CPU 906 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 909 (e.g., 2 DLAs/XNNs/NNAs/NPUs 909), and a vision accelerator—such as a programmable vision accelerator (PVA) 907, a single SoC 904) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 904 include a GPU 908 with 1700 or more cores (e.g., 1792 cores), 50 or more tensor cores (e.g., 56 tensor cores), and a GPU max frequency of over 900 MHz (e.g., 930 MHz), a CPU 906 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 909 (e.g., 2 DLAs/XNNs/NNAs/NPUs 909), and a vision accelerator—such as a programmable vision accelerator (PVA) 907, a single SoC 904) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 904 include a GPU 908 with 1000 or more cores (e.g., 1024 cores), 28 or more tensor cores (e.g., 32 tensor cores), and a GPU max frequency of over 900 MHz (e.g., 1173 MHz), a CPU 906 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 909 (e.g., 1 DLA/XNN/NNA/NPU 909), and a vision accelerator—such as a programmable vision accelerator (PVA) 907, a single SoC 904) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 904 include a GPU 908 with 1000 or more cores (e.g., 1024 cores), 28 or more tensor cores (e.g., 32 tensor cores), and a GPU max frequency of over 900 MHz (e.g., 1020 MHz), a CPU 906 including 6 or more cores (e.g., 6 cores), with 64 bits, 1.5 MB L2 and 4 MB L3 cache memory, and a max frequency of 1.5 or more GHz (e.g., 1.7 GHz), a single SoC 904) may be capable of 67 tera operations per second (TOPS) of AI performance. For example, NVIDIA's Jetson Orin Nano 8 GB SoC satisfies these criteria, and achieves this performance.

The SoC(s) 904 may include one or more CPUs 906. The CPU(s) 906 may include a CPU cluster or CPU complex (alternatively referred to herein as a “CCPLEX”), in embodiments. The CPU(s) 906 may include multiple cores and/or (e.g., L2, L3) caches. For example, in some embodiments, the CPU(s) 906 may include twelve cores in a coherent multi-processor configuration. In some embodiments, the CPU(s) 906 may include four dual-core clusters where each cluster has a dedicated L2 cache (e.g., a 3 MB L2 cache). The CPU(s) 906 (e.g., the CCPLEX) may be configured to support simultaneous cluster operation enabling any combination of the clusters of the CPU(s) 906 to be active at any given time.

The SoC(s) 904 may include any type and number of GPUs 908. For example, an integrated GPU(s) (alternatively referred to herein as an “iGPU(s)”) may be used in some embodiments. The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive, robotics, and/or other embedded use cases. For example, the GPU(s) 908 may be fabricated on a Fin field-effect transistor (FinFET). However, this is not intended to be limiting and the GPU(s) 908 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

The SoC(s) 904 may include any number of cache(s) 912, including those described herein. For example, the cache(s) 912 may include L0 caches, L1 caches, L2 caches, L3 caches (e.g., that are available to both the CPU(s) 906 and the GPU(s) 908 (e.g., that is connected both the CPU(s) 906 and the GPU(s) 908)), etc. The cache(s) 912 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 904 may include one or more arithmetic logic units (ALUs) 965 which may be leveraged in performing processing with respect to any of the variety of tasks or operations of the machine 900—such as computer vision, machine learning or deep learning processing, world model management, etc. In addition, the SoC(s) 904 may include a floating point unit(s) (FPU(s)) 967—or other math coprocessor or numeric coprocessor types—for performing mathematical operations within the system. For example, the SoC(s) 904 may include one or more FPUs 967 integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory 915 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 914 (e.g., the hardware acceleration cluster) may include a deep learning accelerator(s) (DLA) 909 (alternatively referred to herein as “a deep learning accelerator cluster (XNN) 909,” “neural network accelerator (NNA) 909,” or “neural processing unit (NPU) 909”). The DLA(s) 909 may include one or more Tensor processing units (TPUs) 941 that may be configured to provide an additional, e.g., ten trillion operations per second for deep learning applications and inferencing. The TPUs 941 may be accelerators configured to, and optimized for, performing image processing functions (e.g., for CNNs, RCNNs, DNNs, etc.). The DLA(s) 909 may further be optimized for a specific set of neural network types and floating point operations, as well as inferencing. The design of the DLA(s) may provide more performance per millimeter than a general-purpose GPU, and vastly exceeds the performance of a CPU. The TPU(s) 941 may perform several functions, including a single-instance convolution function, supporting, for example, INT8, INT16, and FP16 data types for both features and weights, as well as post-processor functions. Although the TPU(s) 941 are described as being included as part of the DLA(s) 909, this is not intended to be limiting, and the TPU(s) 941 may be included in additional or alternative accelerator(s) 914 and/or other components, and/or may be included as a discrete processing component(s).

The DLA(s) 909 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 909 may perform any function of the GPU(s) 908, and by using an inference accelerator, for example, a designer may target either the DLA(s) 909 or the GPU(s) 908 for any function. For example, the designer may focus processing of DNNs and floating point operations on the DLA(s) 909 and leave other functions to the GPU(s) 908 and/or other accelerator(s) 914. The DLA(s) 909 may be used to run any type of network to enhance control and safety, including for example, a neural network that outputs a measure of confidence for each object detection.

The accelerator(s) 914 (e.g., the hardware acceleration cluster) may include a programmable vision accelerator(s) (PVA) 907, which may alternatively be referred to herein as a computer vision accelerator or generally a vision accelerator. The PVA(s) 907 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 907 may provide a balance between performance and flexibility. For example, each PVA(s) 907 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 907 may be optimized for the tasks of image processing and computer vision algorithm acceleration. For example, the PVA(s) 907 provides excellent performance with extremely low power consumption, and can be used asynchronously and concurrently with the CPU(s) 906, GPU(s) 908, and/or other accelerators in the system (e.g., vehicle, robot, etc.) as part of a heterogeneous compute pipeline.

The PVA(s) 907 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 943 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 906 (e.g., ARM Cortex-R5 processor), facilitating data exchange with the CPU(s) 906 and other system-level components. The VPU I-cache may supply instruction data to the VPU(s) when requested, may request missing instruction data from system memory, and/or may maintain temporary instruction storage for the VPU. For each VPU task, the CPU(s) 906 may configures the DMA system, optionally prefetch the VPU program into VPU I-cache, and/or kick off each VPU-DMA pair to process a task. The PVA(s) 907 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 907 to access the system memory independently of the CPU(s) 906. The DMA may support any number of features used to provide optimization to the PVA(s) 907 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 907 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 907, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 907 may be configured to employ data parallelism. For example, in some embodiments, the plurality of vector processors included in a single PVA(s) 907 may execute the same computer vision algorithm, but on different regions of an image. In other examples, the vector processors included in a particular PVA(s) 907 may simultaneously execute different computer vision algorithms, on the same image, or even execute different algorithms on sequential images or portions of an image. Among other things, any number of PVAs 907 may be included in the hardware acceleration cluster and any number of vector processors may be included in each of the PVAs. In addition, the PVA(s) 907 may include additional error correcting code (ECC) memory, to enhance overall system safety.

The accelerator(s) 914 (e.g., the hardware accelerator cluster) have a wide array of uses for autonomous and semi-autonomous machine control. The PVA(s) 907 may be a programmable vision accelerator that may be used for key processing stages in perception, robotics understanding and reasoning, ADAS, semi-autonomous, and autonomous vehicles, etc. The PVA's 907 capabilities are a good match for algorithmic domains needing predictable processing, at low power and low latency. In other words, the PVA(s) 907 performs well on semi-dense or dense regular computation, even on small data sets, which need predictable run-times with low latency and low power. Thus, in the context of platforms for autonomous vehicles and robotics, the PVAs 907 are designed to run classic computer vision algorithms, as they are efficient at object detection and operating on integer math.

For example, according to one embodiment of the technology, the PVA 907 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 907 may perform computer stereo vision function on inputs from two monocular cameras.

In some examples, the PVA(s) 907 may be used to perform dense optical flow. According to process raw RADAR data (e.g., using a 4D Fast Fourier Transform) to provide Processed RADAR. In other examples, the PVA(s) 907 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 907, this is not intended to be limiting. In some embodiments, these components may be included in alternative or additional processing components and/or accelerator(s) 914, and/or may be included as discrete components of the SoC(s) 904 and/or other computing system architecture(s).

In some examples, the SoC(s) 904 may include a real-time ray-tracing hardware accelerator (RTA) 951 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 900 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 951 and/or a ray-tracing optimized GPU 908—such as NVIDIA's RTX GPU.

The accelerator(s) 914 (e.g., in the hardware acceleration cluster) may include one or more optical flow accelerators (OFAs) 911. For example, the OFA(s) 911 may be used for computing optical flow and stereo disparity between frames of sensor data (e.g., images). Optical flow may be accelerated on the OFA(s) 911 for uses such as object detection and tracking, and/or for stereo depth estimation where used for computing stereo disparity between stereo image frames (e.g., two or more frames captured using two or more image sensors with at least partially overlapping fields of view).

The SoC(s) 904 may include one or more camera serial interfaces (CSIs) 923. For example, the CSI(s) 923 may include a mobile industry processor interface (MIPI) camera serial interface (CSI) for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role. For example, the CSI 923 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 914 (e.g., the hardware acceleration cluster) may include a computer vision network on-chip (CVNOC) 963 and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by the PVA 907, OFA 911, DLA 909, and/or other accelerator(s) 914. Each pair of memory blocks may include an advanced peripheral bus (APB) interface, configuration circuitry, a controller, and a multiplexer. Any type of memory 915 may be used. The PVA 907, OFA 911, DLA 909, and/or other accelerator(s) 914 may access the memory via a backbone that provides the accelerator(s) 914 with high-speed access to memory. The backbone may include a computer vision network on-chip that interconnects the accelerator(s) 914 to the memory (e.g., using the APB).

The CVNOC 963 may include an interface that determines, before transmission of any control signal/address/data, that the accelerator(s) 914 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 904 may include data store(s) 916 and/or memory 915. The data store(s) 916 may be on-chip memory 915 of the SoC(s) 904, which may store neural networks and/or other algorithms to be executed on the CPU(s) 906, the GPU(s) 908, and/or one or more of the accelerator(s) 914. In some examples, the data store(s) 916 may be large enough in capacity to store multiple instances of neural networks for redundancy and safety. The data store(s) 916 may comprise L2 and/or L3 cache(s) 912, for example. The memory(ies) 915 may include SRAM, LPDDR5, and/or other memory types. For example, the memory(ies) 915 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 916 may include reference to the memory associated with the PVA 907, OFA 911, DLA 909, and/or other accelerator(s) 914, as described herein.

The data store(s) 916 may include various storage types, such as eMMC, NVMe, etc. For example, the SoC(s) 904 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 916 and/or other storage may be accessed via, e.g., NVMe, using PCI Express (PCIe), RDMA, TCP, and/or other protocols.

The SoC(s) 904 may include one or more processor(s) 910 (e.g., embedded processors). The processor(s) 910 may include a boot and power management processor (BPMP) 953, that may be a dedicated processor and subsystem to handle boot power and management functions and related security enforcement. The BPMP 953 may be a part of the SoC(s) 904 boot sequence and may provide runtime power management services. The BPMP 953 may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, accelerator(s) 914, and/or other components. If temperatures are determined to exceed a threshold, BPMP 953 may enter a temperature fault routine and put the SoC(s) 904 into a lower power state and/or put the machine 900 into a chauffeur to safe stop mode (e.g., bring the machine 900 to a safe stop).

The processor(s) 910 may further include a set of embedded processors that may serve as an audio processing engine (APE) 955. The APE 955 may be an audio subsystem that enables full hardware support for multi-channel audio over multiple interfaces, and a broad and flexible range of audio I/O interfaces. In some examples, the APE 955 is a dedicated processor core with a digital signal processor with dedicated RAM.

The processor(s) 910 may further include an always on processor engine (AOPE) 957 that may provide necessary hardware features to support low power sensor management and wake use cases. The AOPE 957 may include a processor core, a tightly coupled RAM, supporting peripherals (e.g., timers and interrupt controllers), various I/O controller peripherals, and routing logic.

The processor(s) 910 may further include a safety processor(s) 913 (alternatively referred to as “safety island 913”), which may include a safety cluster engine that includes a dedicated processor or processor subsystem to handle safety management for automotive, robotics, and/or other applications. The safety processor(s) 913—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 913 may include a discrete processor(s), such that fault of other system components may not impact the performance and availability of the safety processor 913.

The processor(s) 910 may further include a real-time or near real-time sensor engine (SE) 959 that may include a dedicated processor subsystem for handling real-time or near real-time camera, LiDAR, RADAR, and/or other sensor modality management.

The processor(s) 910 may further include one or more image signal processors (ISPs) 927, which may include a high-dynamic range signal processor and/or a hardware engine that is part of one or more sensor processing pipelines.

The processor(s) 910 may include a video image compositor (VIC) 961 that may be a processing block (e.g., implemented on a microprocessor) that implements video post-processing functions needed by a video playback application to produce the final image for the player window. The VIC 961 may perform lens distortion correction on wide-view camera(s) 968B, surround camera(s) 968D, in-cabin monitoring camera sensors, and/or other camera sensors with distorted fields of view.

A VIC 961 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 961 may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a broad range of peripheral interfaces for input/output (I/O) 925, such as to enable communication with peripherals, audio codecs, power management, and/or other devices. The SoC(s) 904 may be used to process data from cameras (e.g., connected over Gigabit Multimedia Serial Link and/or Ethernet), sensors (e.g., LiDAR sensor(s) 964, RADAR sensor(s) 960, etc. that may be connected over Ethernet), data from bus 902 (e.g., speed of machine 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks. In some embodiments, the SoC(s) 904 I/O 925 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4 A (+MST), an eDP 1.41, an HDMI 2.1, and/or a 4K30 multi-model DP 1.2 (+MST) connector), and/or other I/O 925 elements, components, or features.

The SoC(s) 904 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 904 may include an RJ45 connector with up to 10 GbE, a 1 GbE connector, and/or other networking connector types.

The SoC(s) 904 may include one or more digital signal processors (DSPs) 943. For example, the DSP(s) 943 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 904 may include one or more video encoders 919 and/or one or more video decoders 921. For example, the video encoder(s) 919 may include a hardware-based (e.g., as part of the GPU(s) 908) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 921 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 921 may be hardware-based (e.g., as part of the GPU(s) 908).

The SoC(s) 904 may include one or more general compute acceleration clusters (GCAC(s)) 929. For example, the GCAC(s) 929 may include various processor types that may be used to accelerate compute, such as one or more vector microcode processors (VMPs) 933, one or more multi-threaded processing clusters (MPCs) 931, one or more programmable macro arrays (PMA(s)) 935, and/or one or more other processor types. For example, the GCAC(s) 929 may include a PMA 935, two VMPs 933, and 2 MPCs 931.

The SoC(s) 904 may include one or more vector microcode processors (VMPs) 933. The VMP(s) 933, in embodiments, may include a wide vector (very long instruction word (VLIW) and single instruction multiple data (SIMD)) machine with performing various operations, such as short integral type operations common in computer vision and deep learning algorithms.

The SoC(s) 904 may include one or more multi-threaded processing clusters (MPCs) 931. The MPC(s) 931 may include a processing cluster that be, in embodiments, more versatile than a GPU, and with higher efficiency than a CPU. For example, the MPC(s) 931 may include a multi-threaded processor that allows multiple threads to share resources and execute instructions concurrently.

The SoC(s) 904 may include one or more programmable macro arrays (PMA(s)) 935. The PMA(s) 935 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 904 may include one or more display processing units (DPUs) 945 for performing hardware-accelerated image processing. For example, the DPU(s) 945 may retrieve pixel data from memory 915 and send it to a display peripheral through standard interfaces. As such, the DPU(s) 945 may handle display processing and rendering for in-machine and/or on-machine displays.

The SoC(s) 904 may include one or more application processing units (APUs) 939. For example, the APU(s) 939 may include a quad or dual-core processor with 48 KB/32 KB L1 cache with parity and ECC, along with a 1 MB L2 cache with ECC. The APU(s) 939 may support NEON instructions and single and double precision floating point operations.

The SoC(s) 904 may include one or more real-time processing units (RTPUs) 969. The RTPU(s) 969 may include a dual-core processor with 32 KB/32 KB L1 cache, and 256 KB TCM with ECC. The RTPU(s) 969 may support single and double precision floating point operations.

The SoC(s) 904 may include one or more built-in self-test (BIST) components 937. For example, the BIST component(s) 937 may include memory BIST (MBIST) to test memories of the system and/or logic BIST (LBIST) to test logic of the system. The BIST components 937 may include embedded logic for directly testing logic and/or memory of the system.

The SoC(s) 904 may include one or more dynamically reconfigurable processors (DRPs) 971. For example, the DRP(s) 971 may be used for accelerating various computing operations. For example, the DRP(s) 971 may be combined, in embodiments, with a MAC unit for use as an AI accelerator. In embodiments, the DRP(s) 971 may execute applications while dynamically switching the circuit connection configuration of the arithmetic units (e.g., ALUs) on the chip at each operating clock according to the content to be processed. Since only the necessary arithmetic circuits are used, the DRP(s) 971 may consume less power than with CPU processing and can achieve higher speed. Furthermore, compared to CPUs, where frequent external memory accesses due to cache misses and other causes will degrade performance, the DRP(s) 971 can build the necessary data paths in hardware ahead of time, resulting in less performance degradation and less variation in operating speed (jitter) due to memory accesses. The DRP(s) 971 may include a dynamic loading function that switches the circuit connection information each time the algorithm changes, enabling processing with limited hardware resources, even in robotic/automotive applications that require processing of multiple algorithms.

In some embodiments, the accelerator(s) 914 may include an OpenCV accelerator for speeding up processing of OpenCV, an open-source industry standard library for computer vision processing. In some embodiments, the combination of one or more DRP(s) 971 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 904 may include various compute engines (e.g., processors 910, CPUs 906, GPU(s) 908, accelerator(s) 914, etc.), tasks may be distributed between and among the compute engines, in some instances without common cause failures due to the discrete footprint of the compute engines. Further, because the SoC(s) 904 may include a dedicated safety processor(s) 913 (or safety island 913), critical safety or redundant operations may be performed without common cause failures from the main processing components or compute engines of the SoC(s) 904. Due to these features, the SoC(s) 904 and/or the underlying systems of the machine 900 may be capable of satisfying higher levels of safety—such as automotive safety integrity level (ASIL) D from the ISO 26262 standard.

FIG. 9E is a system diagram for communication between a cloud-based server(s) (e.g., in a data center, such as those described herein) and the example autonomous or semi-autonomous vehicle or machine 900 of FIG. 9A, in accordance with some embodiments of the present disclosure. The system 976 may include a server(s) 978, a network(s) 990, and a machine(s) 900. The server(s) 978 may include a plurality of GPUs 984(A)-984(H) (collectively referred to herein as GPUs 984), switches 982(A)-982(D) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 980(A)-980(B) (collectively referred to herein as CPUs 980), accelerators, and/or other processor types. The GPUs 984, the CPUs 980, and the PCIe switches 982 may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and four PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the machine(s) 900, sensor data indicating information about new or previously unexplored locations, and/or sensor data indicating changes to previously seen/stored locations (e.g., unexpected or changed road conditions, such as recently commenced road-work). The server(s) 978 may transmit, over the network(s) 990 and to the machine(s) 900, neural networks 992, updated neural networks 992, map information 994, etc., including information regarding traffic and road conditions. The updates to the map information 994 may include updates for the HD map 922, SD map, navigation map, etc., such as information regarding construction sites, potholes, detours, flooding, and/or other obstructions. In some examples, the neural networks 992, the updated neural networks 992, the map information 994, and/or the other information may have resulted from new training and/or experiences represented in data received from any number of machine(s) 900 in the environment, and/or based on training performed at a datacenter (e.g., using the server(s) 978 and/or other servers).

The server(s) 978 may be used to train machine learning models (e.g., neural networks) based on training data. The training data may be generated by the machine(s) 900, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 900 (e.g., transmitted to the machine(s) 900 over the network(s) 990, and/or the machine learning models may be used by the server(s) 978 to remotely monitor and/or control the machine(s) 900.

In some examples, the server(s) 978 may receive data from the machine(s) 900 and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the machine 900. For example, the deep-learning infrastructure may receive periodic updates from the machine 900, such as a sequence of images and/or objects that the machine 900 has located in that sequence of images (e.g., via computer vision and/or other machine learning object classification techniques). The deep-learning infrastructure may run its own neural network to identify the objects and compare them with the objects identified by the machine 900 and, if the results do not match and the infrastructure concludes that the AI in the machine 900 is malfunctioning, the server(s) 978 may transmit a signal to the machine 900 instructing a fail-safe computer of the machine 900 to assume control, notify the passengers, and complete a safety maneuver or operation—such as to slow down, hand control back to a driver, come to a stop, and/or pull over/shut down.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem FOR Generating, Training, and Deploying AI

FIG. 10 is a system diagram illustrating a three computer ecosystem 1000, including a first computing system 1002 for generating or creating artificial intelligence (AI) such as AI training and validation data, a second computing system 1004 for training artificial intelligence, and a third computing system 1006 (which may include or correspond to the SoC(s) 904 of FIGS. 9A-9E) deploying the AI at the edge, in accordance with at least some embodiments of the present disclosure. For example, to develop and deploy embodied or physical AI, the three computer ecosystem 1000 may be used, including three accelerated computer systems to handle physical AI training, simulation, and runtime (e.g., edge deployment). These systems may generate training data for and train multimodal foundation models (and/or other model types) using scalable, physically based simulations of the machine(s) 900 and their worlds. By doing so, simulation of machine(s) 900 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 900 can perform safely in controlled settings.

The computing system 1004 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) 900 to understand natural language and emulate movements by observing human actions. The computing system 1004 may include a platform that incorporates software, infrastructure, and expertise in a modern, unified AI development and training solution. The computing system 1004 may include individual computing devices 1010 (e.g., NVIDIA's DGX B200, H200, etc.) and/or any number of computing devices 1010 in a data center infrastructure 1012 (e.g., NVIDIA's DGX SuperPOD).

For example, the individual computing devices 1010 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 1010 may include memory (e.g., 4 TB memory, and storage (e.g., OS storage of 2×1.9 TB NVMe M.2, and internal storage of 8×3.84 TB NVMe U.2). The computing devices 1010 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1010 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 1010 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1010 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1010 may include a smart host channel adapter (HCA) (e.g., NVIDIA's ConnectX-7) to provide ultra-low latency, 400 Gb/s throughput for in-network computing acceleration engines.

The data center infrastructure 1012 may include any number of the computing devices 1010, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1010) to thousands, job scheduling and orchestration to ensure hassle-free execution of every developer's job, AI workflow management and machine learning operations (MLOps) to move more models from prototype to production, and enterprise software to speed developer success.

The computing system 1002 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1002 allows developers to use simulation frameworks to simulate and validate robot models, and/or to generate massive amounts of physically-based synthetic data to bootstrap model training. The computing system 1002 may support learning frameworks that power robot reinforcement learning and imitation learning, to accelerate robot policy training and refinement. For example, the computing system 1002 may be used to generate any number of simulations 1008—such as within NVIDIA's OMNIVERSE. The computing system 1002 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1002 may host or support a native OpenUSD software platform enabling enterprises to connect 3D pipelines and develop advanced, real-time 3D applications for industrial digitalization. With powerful ray-tracing-accelerated AI and graphics capabilities, the computing system 1002 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1002 may include individual computing devices 1014 (e.g., NVIDIA's OVX L40S Server) and/or any number of computing devices 1014 in a data center infrastructure 1016 (e.g., NVIDIA's OVX Systems).

The computing device(s) 1014 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen 4×16: 64 GB/s bidirectional interconnect interface, 18,176 CUDA cores, 142 ray tracing (RT) cores, and 568 tensor cores). The computing devices 1014 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 1014 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1014 may include a smart host channel adapter (HCA) (e.g., NVIDIA's ConnectX-7) to provide ultra-low latency, 400 Gb/s throughput for in-network computing acceleration engines. The computing device(s) 1014 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 1012, the data center infrastructure 1016 may allow for any number of computing device(s) 1014 to be combined in cluster configuration according to a reference architecture.

The computing system 1006 may be used to deploy trained AI models on a runtime computer—such as the SoC(s) 904 described herein. For example, these computing systems 1006 may be designed for compact, on-board computing needs, including an ensemble of models for control policy, vision and language models, etc., deployed on a power-efficient on-board edge computing system 1006. Details of components, features, and capabilities of the computing system 1006 may be described in more detail herein with respect to FIGS. 9A-9E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms-may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11 is a block diagram of an example generative language model system 1100 suitable for use in implementing at least some embodiments of the present disclosure. In the example illustrated in FIG. 11, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a MMLM, a VLA model, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization (TN), for example, by converting all characters to lowercase, removing accents, and/or or handling special cases like contractions or abbreviations to ensure consistency (e.g., converting ¼ to one quarter). Similarly, the input processor 1105 and/or a post-processor may perform inverse text normalization (ITN) in order to convert plain language back to canonical or other forms (e.g., to convert one quarter to ¼) . These are just a few examples, and other types of input and/or output processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data/video data/etc., the input processor 1105 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1105 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1105 may extract frames or apply resizing to extracted frames, and the embedding component 1120 may extract features such as optical flow embeddings or video embeddings and/or may encode temporal information or sequences of frames. In some implementations in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s), speaker(s), etc.), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine numerous scenarios involving interactions between ego machines and object machines and/or occlusions, and to mine these scenarios to define even more scenarios to train machine learning models, etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., scenarios involving actual or potential interactions between ego machines and agent machines and/or occlusions from within the simulation. The synthetic training data (in addition to or alternatively from real-world data) may then be used or processed to mine scenarios involving ego machines and agent machines and/or occlusions.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to mine scenarios involving interactions between ego machines and agent machines and/or occlusions, wherein the scenarios may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

The disclosed systems and methods also include a data-generation pipeline that includes a simulator that performs various types of simulations related to a machine (e.g., an ego machine) navigating within an environment (e.g., a roadway). Data generated by the simulator based on the simulations includes (but is not limited to) rendered images of the environment around the machine (e.g., from the perspective of one or more cameras on the machine and/or a birds-eye visualization), semantic labels (e.g., segmentation maps, detected objects, bounding shapes, etc.) associated with the images, a state of the machine (e.g., position, heading, velocity, etc.), and/or a map of free and/or occupied space within the environment. The data-generation pipeline also includes a scenario generator that determines a goal within the map, such as (but not limited to) a target location to navigate to within the environment.

The data-generation pipeline additionally includes a planner that generates a command to the machine to take an action related to the scenario, such as a linear and/or angular velocity that causes the machine to follow the scenario. The command is sent to the simulator, which updates the state of the machine, rendered images, semantic labels, map, and/or other data based on the action. The simulator also sends some or all of the updated data to the planner to allow the planner to generate a new command based on the updated data and the goal from the scenario generator. This process repeats until the goal is reached by the machine, a certain number of time steps has been executed within the simulation, and/or another condition indicating the end of the simulation is met.

The data-generation pipeline further includes a logger that records and synchronizes data outputted by the other components across time steps. For example, the logger may log data from the other components in the order in which the corresponding events occur within the simulation. The logger may also downsample some or all of the data (e.g., on a spatial and/or temporal basis) to reduce the size of the logged data.

A post-processor in the data-generation pipeline adapts the generated data to various machine learning models and/or use cases. For example, the post-processor may resample, compress, format, and/or otherwise convert the generated data into a form that can be used to train and/or evaluate a machine learning model, hardware configuration, and/or other components of the machine.

The data-generation pipeline can be configured and/or customized via one or more sets of configuration parameters. For example, the configuration parameters may include a unique name and/or identifier for a given scenario (e.g., a combination of a particular environment, machine, goal, policy, etc.) under which data is to be generated and collected. The configuration parameters may also be used to customize the environment and/or type of machine to be simulated, the goal, the type of planner, the type of data to log, the frequency with which the data is logged, and/or the way in which the logged data is converted into a format that is suitable for training and/or evaluating a machine learning model and/or another component of the machine. Different sets of configuration parameters can be used to launch different instances of the data-generation pipeline (e.g., in parallel on multiple nodes of a distributed system) to generate data that captures different scenarios related to navigation and/or other types of tasks performed by machines in environments.

One advantage of the disclosed systems and methods relative to prior approaches is the ability to generate training data comprising a large number of different scenarios quickly, taking advantage of caching of data in the execution engine. Another advantage of the disclosed systems and methods is the ability to define scenarios that span diverse environments, machine types, behaviors, and/or other types of data related to navigation and/or other tasks performed by machines. These scenarios may be used to train, test, and/or evaluate/validate machine learning models and/or other components of the machines, thereby facilitating fault tolerance and/or generalization of the machines to different scenarios and/or use cases. These scenarios also may be used to train machine learning models to generate a wider range of data (additional scenarios) to evaluate/validate the system.
1. In some embodiments, a method comprises: receiving first data describing one or more agent trajectories and one or more agent types of one or more agent machines in an environment, and second data describing an ego trajectory and an ego type of an ego machine in the environment, the first data including speed and acceleration of each of the one or more agent machines, the second data including speed and acceleration of the ego vehicle, one of the first data or second data including a distance of each of the one or more agent machines from the ego machine; defining a scenario that includes at least one interaction between the one or more agent machines and the ego machine in the environment, the at least one interaction including one or more of relative speed, relative distance, or relative acceleration between the ego machine and a respective one of the one or more agent machines; and identifying, based on the first data and the second data, third data that represents the at least one interaction included in the scenario.
2. The method of clause 1, further comprising varying one or more of the first or second data to define at least one additional scenario that includes at least one further interaction between the one or more agent machines and the ego machine in the environment, the third data further representing the at least one interaction included in the at least one additional scenario.
3. The method of clause 1 or clause 2, further comprising varying one or more of agent types of the one or more agent machines or ego type of the ego machine to define at least one additional scenario that includes at least one further interaction between the one or more agent machines and the ego machine in the environment, the third data further representing the at least one interaction included in the at least one additional scenario.
4. The method of any of clauses 1 to 3, further comprising varying one or more of the relative speed, relative acceleration, or relative distance between the ego machine and each of the one or more agent machines to define at least one additional scenario that includes at least one further interaction between the one or more agent machines and the ego machine in the environment, the third data further representing the at least one interaction included in the at least one additional scenario.
5. The method of any of clauses 1 to 4, wherein one or more of the first data or second data comprise one or more of offline detection and tracking data, online detection and tracking data from a plurality of sensors on the ego machine, or human labeled data.
6. The method of any of clauses 1 to 5, wherein the at least one interaction comprises one or more of the following: straight line constant velocity movement between the ego machine and the one or more agent machines; lane change by the one or more agent machines in front of the ego machine; overtaking of the ego machine by the one or more agent machines; acceleration of at least one of the one or more agent machines relative to the ego machine; curved road constant velocity movement between the ego machine and the one or more agent machines; respective movement between the ego machine and the one or more agent machines in opposite directions such that the ego machine and the one or more agent machines are approaching each other; deceleration of at least one of the one or more agent machines in front of the ego machine; movement of the ego machine and the one or more agent machines in the same direction such that the ego machine and the one or more agent machines are moving in the same direction alongside each other; the ego machine is approaching at least one stationary agent machine; overtaking of the ego machine by the one or more agent machines, wherein at least one of the one or more agent machines accelerates relative to the ego machine, difference in size between the ego machine and the at least one of the one or more agent machines; occlusion, by one of the one or more of the agent machines, of the ego machine from another of the one or more agent machines; at least one of the one or more agent machines passes on either side of the ego machine; the ego machine executing a turn with at least one of the one or more agent machines nearby; the ego machine in stop and go traffic in proximity to one or more agent machines; the ego machine proceeding behind one or more agent machines which occupy the same lane as the ego machine, and at least one lane on either side of the ego machine; the ego machine approaching one or more agent machines that are parked; or one or more of the agent machines blocking a view of the ego machine of a much smaller object that is crossing in front of the ego machine.
7. The method of any of clauses 1 to 6, further comprising receiving fourth data comprising one or more occlusions present in the environment, the defining comprising at least one interaction between the one or more agent machines and the ego machine in the environment in the presence of the one or more occlusions.
8. The method of any of clauses 1 to 7, further comprising training one or more machine learning systems on the third data.
9. The method of any of clauses 1 to 8, wherein the ego machine and the one or more agent machines are selected from the group consisting of autonomous machines and semi-autonomous machines.
10. The method of any of clauses 1 to 9, wherein the autonomous machines and semi-autonomous machines are selected from the group consisting of autonomous or semi-autonomous vehicles, autonomous or semi-autonomous mobile robot, autonomous or semi-autonomous humanoid robot, watercraft, underwater craft, drones, or aircraft.
11. In some embodiments, at least one processor comprises: processing circuitry to cause performance of operations comprising: receiving first data describing one or more agent trajectories and one or more agent types of one or more agent machines in an environment, and second data describing an ego trajectory and an ego type of an ego machine in the environment, the first data including speed and acceleration of each of the one or more agent machines, the second data including speed and acceleration of the ego vehicle, one of the first data or second data including a distance of each of the one or more agent machines from the ego machine; defining a scenario that includes at least one interaction between the one or more agent machines and the ego machine in the environment, the at least one interaction including one or more of relative speed, relative distance, or relative acceleration between the ego machine and a respective one of the one or more agent machines; and identifying, based on the first data and the second data, third data that represents the at least one interaction included in the scenario.
12. The at least one processor of clause 11, wherein the operations further comprise varying one or more of the first or second data to define at least one additional scenario that includes at least one further interaction between the one or more agent machines and the ego machine in the environment, the third data further representing the at least one interaction included in the at least one additional scenario.
13. The at least one processor of clause 11 or clause 12, wherein the operations further comprise varying one or more of agent types of the one or more agent machines or ego type of the ego machine to define at least one additional scenario that includes at least one further interaction between the one or more agent machines and the ego machine in the environment, the third data further representing the at least one interaction included in the at least one additional scenario.
14. The at least one processor of any of clauses 11 to 13, wherein the operations further comprise varying one or more of the relative speed, relative acceleration, or relative distance between the ego machine and each of the one or more agent machines to define at least one additional scenario that includes at least one further interaction between the one or more agent machines and the ego machine in the environment, the third data further representing the at least one interaction included in the at least one additional scenario.
15. The at least one processor of any of clauses 11 to 14, wherein one or more of the first data or second data comprise one or more of offline detection and tracking data, online detection and tracking data from a plurality of sensors on the ego machine, or human labeled data.
16. The at least one processor of any of clauses 11 to 15, wherein the operations further comprise receiving fourth data comprising one or more occlusions present in the environment, the defining comprising at least one interaction between the one or more agent machines and the ego machine in the environment in the presence of the one or more occlusions.
17. The at least one processor of any of clauses 11 to 16, wherein the operations further comprise training one or more machine learning systems on the third data.
18. The at least one processor of any of clauses 11 to 17, wherein the at least one processor is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
19. In some embodiments, a system comprises: one or more processors to receive first data describing one or more agent trajectories and one or more agent types of one or more agent machines in an environment, and second data describing an ego trajectory and an ego type of an ego machine in the environment, to define a scenario that includes at least one interaction between one or more agent machines and an ego machine in an environment, the at least one interaction including one or more of relative speed, relative distance, or relative acceleration between the ego machine and a respective one of the one or more agent machines.
20. The system of clause 19, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving first data describing one or more agent trajectories and one or more agent types of one or more agent machines in an environment, and second data describing an ego trajectory and an ego type of an ego machine in the environment, the first data including speed and acceleration of each of the one or more agent machines, the second data including speed and acceleration of the ego vehicle, one of the first data or second data including a distance of each of the one or more agent machines from the ego machine;
defining a scenario that includes at least one interaction between the one or more agent machines and the ego machine in the environment, the at least one interaction including one or more of relative speed, relative distance, or relative acceleration between the ego machine and a respective one of the one or more agent machines; and
identifying, based on the first data and the second data, third data that represents the at least one interaction included in the scenario.

2. The method of claim 1, further comprising varying one or more of the first or second data to define at least one additional scenario that includes at least one further interaction between the one or more agent machines and the ego machine in the environment, the third data further representing the at least one interaction included in the at least one additional scenario.

3. The method of claim 1, further comprising varying one or more of agent types of the one or more agent machines or ego type of the ego machine to define at least one additional scenario that includes at least one further interaction between the one or more agent machines and the ego machine in the environment, the third data further representing the at least one interaction included in the at least one additional scenario.

4. The method of claim 1, further comprising varying one or more of the relative speed, relative acceleration, or relative distance between the ego machine and each of the one or more agent machines to define at least one additional scenario that includes at least one further interaction between the one or more agent machines and the ego machine in the environment, the third data further representing the at least one interaction included in the at least one additional scenario.

5. The method of claim 1, wherein one or more of the first data or second data comprise one or more of offline detection and tracking data, online detection and tracking data from a plurality of sensors on the ego machine, or human labeled data.

6. The method of claim 1, wherein the at least one interaction comprises one or more of the following:
straight line constant velocity movement between the ego machine and the one or more agent machines;
lane change by the one or more agent machines in front of the ego machine;
overtaking of the ego machine by the one or more agent machines;
acceleration of at least one of the one or more agent machines relative to the ego machine;
curved road constant velocity movement between the ego machine and the one or more agent machines;
respective movement between the ego machine and the one or more agent machines in opposite directions such that the ego machine and the one or more agent machines are approaching each other;
deceleration of at least one of the one or more agent machines in front of the ego machine;
movement of the ego machine and the one or more agent machines in the same direction such that the ego machine and the one or more agent machines are moving in the same direction alongside each other;
the ego machine is approaching at least one stationary agent machine;
overtaking of the ego machine by the one or more agent machines, wherein at least one of the one or more agent machines accelerates relative to the ego machine,
difference in size between the ego machine and the at least one of the one or more agent machines;
occlusion, by one of the one or more of the agent machines, of the ego machine from another of the one or more agent machines;
at least one of the one or more agent machines passes on either side of the ego machine;
the ego machine executing a turn with at least one of the one or more agent machines nearby;
the ego machine in stop and go traffic in proximity to one or more agent machines;
the ego machine proceeding behind one or more agent machines which occupy the same lane as the ego machine, and at least one lane on either side of the ego machine;
the ego machine approaching one or more agent machines that are parked; or
one or more of the agent machines blocking a view of the ego machine of a much smaller object that is crossing in front of the ego machine.

7. The method of claim 1, further comprising receiving fourth data comprising one or more occlusions present in the environment, the defining comprising at least one interaction between the one or more agent machines and the ego machine in the environment in the presence of the one or more occlusions.

8. The method of claim 1, further comprising training one or more machine learning systems on the third data.

9. The method of claim 1, wherein the ego machine and the one or more agent machines are selected from the group consisting of autonomous machines and semi-autonomous machines.

10. The method of claim 1, wherein the autonomous machines and semi-autonomous machines are selected from the group consisting of autonomous or semi-autonomous vehicles, autonomous or semi-autonomous mobile robot, autonomous or semi-autonomous humanoid robot, watercraft, underwater craft, drones, or aircraft.

11. At least one processor comprising:
processing circuitry to cause performance of operations comprising:
receiving first data describing one or more agent trajectories and one or more agent types of one or more agent machines in an environment, and second data describing an ego trajectory and an ego type of an ego machine in the environment, the first data including speed and acceleration of each of the one or more agent machines, the second data including speed and acceleration of the ego vehicle, one of the first data or second data including a distance of each of the one or more agent machines from the ego machine;
defining a scenario that includes at least one interaction between the one or more agent machines and the ego machine in the environment, the at least one interaction including one or more of relative speed, relative distance, or relative acceleration between the ego machine and a respective one of the one or more agent machines; and
identifying, based on the first data and the second data, third data that represents the at least one interaction included in the scenario.

12. The at least one processor of claim 11, wherein the operations further comprise varying one or more of the first or second data to define at least one additional scenario that includes at least one further interaction between the one or more agent machines and the ego machine in the environment, the third data further representing the at least one interaction included in the at least one additional scenario.

13. The at least one processor of claim 11, wherein the operations further comprise varying one or more of agent types of the one or more agent machines or ego type of the ego machine to define at least one additional scenario that includes at least one further interaction between the one or more agent machines and the ego machine in the environment, the third data further representing the at least one interaction included in the at least one additional scenario.

14. The at least one processor of claim 11, wherein the operations further comprise varying one or more of the relative speed, relative acceleration, or relative distance between the ego machine and each of the one or more agent machines to define at least one additional scenario that includes at least one further interaction between the one or more agent machines and the ego machine in the environment, the third data further representing the at least one interaction included in the at least one additional scenario.

15. The at least one processor of claim 11, wherein one or more of the first data or second data comprise one or more of offline detection and tracking data, online detection and tracking data from a plurality of sensors on the ego machine, or human labeled data.

16. The at least one processor of claim 11, wherein the operations further comprise receiving fourth data comprising one or more occlusions present in the environment, the defining comprising at least one interaction between the one or more agent machines and the ego machine in the environment in the presence of the one or more occlusions.

17. The at least one processor of claim 11, wherein the operations further comprise training one or more machine learning systems on the third data.

18. The at least one processor of claim 11, wherein the at least one processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. A system comprising:
one or more processors to receive first data describing one or more agent trajectories and one or more agent types of one or more agent machines in an environment, and second data describing an ego trajectory and an ego type of an ego machine in the environment, to define a scenario that includes at least one interaction between one or more agent machines and an ego machine in an environment, the at least one interaction including one or more of relative speed, relative distance, or relative acceleration between the ego machine and a respective one of the one or more agent machines.

20. The system of claim 19, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
